(19) United States
(12) Patent Application Publication
(10) Pub. No.: US 2002/0138819 A1
(43) Pub. Date: Sep. 26, 2002

(54) Computer programming language to describe and encapsulate a computer as a set of classes and objects

(76) Inventor: Theodore S. Hills, Lambertville, NJ (US)

Correspondence Address: CANTOR COLBURN, LLP, 55 GRIFFIN ROAD SOUTH, BLOOMFIELD, CT, 06002

(21) Appl. No.: 09/741,502

(22) Filed: Dec. 19, 2000

(51) Int. Cl. G06F 9/45

(52) U.S. Cl. 717/114

(57) ABSTRACT

A computer programming language to describe and encapsulate a computer as a set of classes and objects is presented. More specifically, an object-oriented programming language method describes and encapsulates the structure and behavior of all software-visible objects making up a digital computer, as well as any abstract object normally described by an object-oriented programming language. This programming language method is suitable to use as a universal assembly language for any computer which can be described in the language, as an intermediate language in compilation, and as a source language for high-level programming using an object-oriented approach. The availability of such a language also makes possible a new method of compilation, and a new method of re-targeting a source program.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO A MICROFICHE APPENDIX

This specification includes a microfiche Appendix comprising Listings 1-7. In this specification, any reference to any of these Listings will be found in this microfiche Appendix.

### BACKGROUND OF THE INVENTION

This invention relates generally to programming of digital computers, and, more specifically, to a computer programming language to describe and encapsulate a computer as a set of classes and objects.

### High-Level and Object-Oriented Programming Languages

The first computer widely regarded as a digital, stored-program computer was the ENIAC, built in 1946. Like all early computers, it was programmed directly in its machine language, using binary or decimal numbers. Using symbols to represent first the numbers of machine operation codes, and then the addresses of data in memory, was an obvious refinement. This refinement yielded an artificial language, a programming language unique to a computer's architecture and instruction set, which was (generically) named “assembly language”.

Programming in assembly language (using symbols) is less tedious than programming in machine language (using nothing but numbers), but still forces the programmer to deal at a very low level of abstraction. Abstractions higher than those present in the computer itself cannot be expressed very well, or at all, in an assembly language program. This gave impetus to the development of so-called high-level programming languages, such as COBOL and FORTRAN, in the late 1950s. These made it possible to express more complex data types than were necessarily built into a computer's hardware.

A new high-level programming language, the Simula language, invented in 1962, introduced the concept of “classes” as programming artifacts representing the descriptions of groups of similar objects. The Simula language was designed primarily to enable the simulation of actual physical objects outside the computer, whose behavior was to be simulated by a computer program. However, it was also contemplated that the programming language could describe abstract objects which only existed as artifacts of a computer program.

Thought began to be given to the form of programs themselves. Based on the concepts of “classes” and “objects” introduced by Simula, a series of programming languages began to be developed in the 1970s and 1980s, which were either object-based or object-oriented. These include Ada, C++, and Smalltalk. Since that time, the expressive power of the concepts of classes and objects has been so widely recognized that “object-oriented programming languages” are the dominant programming languages in the world today. There is much commercial impetus to introduce no new languages but object-oriented ones. This is evidenced by the fact that the newest commercially significant programming languages, Java® from Sun Microsystems, and C# from Microsoft, are object-oriented. (Java® is a registered trademark of Sun Microsystems, Inc.)

This progression from machine languages, through assembly languages and high-level languages, to object-oriented languages, has enabled programmers to express ideas at higher and higher levels of abstraction, leaving the details of implementation on a particular computer architecture to software written expressly to make that transition, namely compilers and software libraries. It has also led to a belief that higher levels of software development productivity will only be achieved as more and more details of implementation on a computer can be left behind. Language designers are progressively moving programming languages away from any ability to express particulars about a computer's architecture. Their goal is to prevent programmers from inadvertently working at too low a level of abstraction, thus reducing their own productivity, and to prevent them from writing programs that are specific to one computer architecture, thus reducing the portability of their programs from one architecture to another.

A side effect of this progression is that programmers who must work in an architecture-specific way lose the ability to employ all of the expressive power of an object-oriented programming language. Consider as evidence the implementation of Java® Virtual Machines (JVMs). Java® is an object-oriented programming language containing no features whatsoever to allow a programmer to access or describe the underlying computer executing a program. For each kind of computer architecture on which it is desired to run a Java® program, a JVM must be written. The task of a JVM is to interpret the binary version of a Java® program (so-called “byte code”, also known as “p-code”), and carry out its intentions on a particular computer. Thus, a JVM is of necessity specific to a single computer architecture. Since Java® cannot access or describe the specifics of an arbitrary computer architecture, no JVM can be written in the Java® programming language. Most JVMs are written in the “C” programming language, a non-object-oriented high-level language.

### Compiler Construction Practices

It is a well-established practice, when compiling a high-level or object-oriented program into machine language, to translate a source program into one or perhaps two intermediate forms before finally translating it into machine language. These intermediate forms are described by so-called “intermediate languages”. An intermediate language is designed to be capable of expressing ideas at some abstraction level between the high abstraction level of a source language and the very low abstraction level of a machine language. For example, three intermediate languages are introduced in Muchnick, Steven, “Advanced Compiler Design & Implementation,” San Francisco, Calif., Morgan Kaufmann Publishers, 1997, which is incorporated herein by reference. These languages are named High-level Intermediate Representation, Medium-level Intermediate Representation, and Low-level Intermediate Representation, indicating respectively by their names that they represent concepts and abstractions close to a source language being compiled, midway between a source language and a machine language that is the target of compilation, and close to a machine language.

Such an intermediate level of abstraction is necessary to a compiler's design, so that the compiler can operate on concerns of optimization and code generation which may not be visible at a higher or lower level of abstraction. For instance, a high-level or object-oriented language typically cannot identify individual registers in the target computer architecture, and therefore a compiler cannot express register allocation using a high-level language. A lower-level language is needed, closer to the actual machine language. Conversely, it may be difficult in a program expressed in a low-level language to recognize loops which can be optimized by unrolling them. Such loops can be more easily recognized in a higher-level language.

This practice of using multiple languages, each of which lends itself more effectively to a particular task of the compiler, complicates the task of the compiler programmer. The intellectual burden of the compiler programmer is increased by having to deal with not only the translation of a program in a high-level language to a program in a machine language, but also translation to one or two other languages along the way.

### BRIEF SUMMARY OF THE INVENTION

The above-discussed and other drawbacks and deficiencies of the prior art are overcome or alleviated by a computer programming language to describe and encapsulate a computer as a set of classes and objects.

In accordance with the present invention, an object-oriented programming language describes and encapsulates the structure and behavior of all software-visible objects making up a digital computer, as well as any abstract object normally described by an object-oriented programming language. The present invention is suitable for use as an assembly language for any computer which can be described in the language, as an intermediate language in compilation, and as a source language for high-level programming using an object-oriented approach.

The availability of such a language also makes possible a new method of compilation, a new method of re-targeting a source program, and a new method of cross-compilation.

The above-discussed and other features and advantages of the present invention will be appreciated and understood by those skilled in the art from the following detailed description and drawings.

### BRIEF DESCRIPTION OF THE SEVERAL VIEWS OF THE DRAWING

Referring now to the drawing wherein like elements are numbered alike in the several FIGURES:

FIG. 1 is a Unified Modeling Language (UML) diagram showing the definitions of the infinite numeric types in the programming language of the present invention, and their subtype/supertype relationships;

FIG. 2 is a UML diagram showing the definitions of the interfaces of the classes representing some of the finite binary numeric types in the programming language of the present invention, and their relationships;

FIG. 3 is a pictorial representation of the so-called Application Programming Registers in the Intelg Architecture for 32-bit computers, Intel® is a registered trademark of Intel Corporation;

FIG. 4 is a UML diagram depicting the family of classes representing inline pointers to the first argument of an instruction in the Intel® Architecture for 32-bit computers;

FIG. 5 is a UML diagram depicting the family of classes representing inline pointers to the second argument of an instruction in the Intel® Architecture for 32-bit computers; and

FIG. 6 is a UML diagram showing two implementations of a 32-bit integer on an Intel® Architecture computer, in the programming language of the present invention, one implementation stores an integer in a register, and the other implementation stores an integer in main memory.

### DETAILED DESCRIPTION OF THE INVENTION

The present invention is an object-oriented programming language, hereinafter called the “D language”, with a syntactic structure that allows the description as object-oriented classes of classes of physical objects (registers, memory, and so forth) that hold state in computers and that are visible to software, with computer instructions described as methods and functions of those classes. The language also enables identifying software-visible physical objects composing computers as pre-existing instances of the aforesaid classes. This allows the D language to be used as a universal assembly language for all computer architectures described in the D language. Such a use of the D language is termed assembly-level programming.

The D language eliminates the prior art process of translation of a source program into an assembly language or any intermediate languages. This will allow for many advances in compiler technology, as compiler writers will be freed from the intellectual burden of dealing with several programming languages, and can concentrate on the allocation and optimization problems which are at the core of compilation.

The D language compiler still rewrites a program, as any compiler does. However, the rewriting process is controlled and constrained by the substitutability principle, that in all cases a reference to an object of a class may be substituted for a reference to an object of an ancestor class. The rewriting process is further controlled and constrained by the type system of the D language, which expresses subtype relationships on an axis separate from subclass relationships. Further, the D language expresses representation relationships, where classes are declared to represent values of types through their interfaces.

Because the D language is an object-oriented programming language, it can also be used to express ideas at a high level of abstraction, far away from the particulars of any computer architecture, in the same way that any object-oriented programming language can be used.

The D language is also able to describe elements of itself. In particular, the D language includes descriptions written in the D language of abstract types, classes, and interfaces which are intrinsic to the D language itself.

Because of the ability of the D language to describe both abstract ideas and concrete computers, a novel method of compilation is made possible. In this method, several aspects of compilation which are traditionally coded directly into the source code of compilers are externalized by expressing them in D language source code, and form part of the input during compilation.

In the specification below, reference will be made to “the D language compiler” or simply “the compiler”. This is to be understood as not only the particular compiler which implements the programming language of the preferred embodiment of the present invention, but any compiler which may be written to implement said programming language.

As an aid to understanding the teaching in this document, in the following sections characters enclosed in single quotation marks, as in ‘this text’, are to be interpreted as characters which could appear in the source code of a D language program exactly as shown in this text, without the enclosing single quotation marks.

### The D Language Syntax

Following this section, the D language will be presented in an intuitively acceptable form. For reference, the D language lexicon and grammar are presented here.

### Lexical Principles

The D language is lexically similar to contemporary languages such as C++ and Java®.

### White Space

White space is optional between tokens of differing lexical categories. That is to say, if the characters of two tokens of differing lexical categories are adjacent in a text, with no intervening characters, then they are distinguishable from one another. Likewise, if white space appears between them, the white space has no effect on the lexical tokens generated from the text. For example, parsing either the character string ‘++a’ or the character string ‘++ a’ generates the same two tokens, the operator symbol ‘++’ and the identifier ‘a’. However parsing the character string ‘+ + a’ generates three tokens, the operator symbol ‘+’ twice, and the identifier ‘a’.

The above principle implies that tokens of the same lexical category must be separated by white space. For example, the character string ‘orderedtype x’ is lexically parsed into two identifiers, ‘orderedtype’ and ‘x’. By contrast, the character string ‘ordered type x’ is lexically parsed into two keywords, ‘ordered’ and ‘type’, and the identifier ‘x’. Similarly, the character string ‘a:=+b’ is parsed into three tokens, the identifier ‘a’, the (undefined) operator symbol ‘:=+’, and the identifier ‘b’. By contrast, the character string ‘a:= +b’ is parsed into four tokens, the identifier ‘a’, the two operator symbols ‘:=’ and ‘+’, and the identifier ‘b’.

The end of a line of text is treated the same as any white space, except that tokens which may include white space (for example, character string tokens) may not include the end of a line. Comments do not extend past the end of a line.

### Comments

A comment begins with two consecutive number signs and ends with the end of the line on which it begins. A comment has the same lexical effect as the end of a line.

### Words

A string of letters, underscores, and decimal digits, where the initial character is a letter or underscore, is called a word. Two kinds of tokens are words: keywords and identifiers. There is a finite set of keywords defined by the language. Each keyword represents a unique lexical category, or token type. All other words are identifiers, whose token type in the grammar is ID.

With regard to alphabetic letters, the language is case-insensitive, case-preserving. This means that two words which differ only in case are treated as the same word (case insensitive). However, the case used in the defining occurrence of a word is treated as the case which is definitive for that word (case preserving).

### Identifiers

Identifiers come in three categories: special, pre-defined, and user-defined. There is a finite set of identifiers used for special purposes within the language (the special identifiers). There is also a finite set of identifiers pre-defined by the language to represent some object whose definition is intrinsic to the language (the predefined identifiers). All other identifiers must be defined within the program text where they are used.

Pre-defined and special identifiers are not keywords, because their lexical category is ID, the same as all other identifiers. This implies that, syntactically, pre-defined identifiers and special identifiers may be used where any other identifier may be used, and vice-versa.

### Predefined Identifiers

A predefined identifier is an identifier of an object whose definition is an intrinsic or essential part of the language. An object is an intrinsic part of the language if the definition of the language depends on the definition of the object, and/or if the object's definition cannot be expressed in the language. An object is an essential part of the language if its definition is included in the definition of the language.

Examples of predefined identifiers include the class meta-class ‘Class_c’, the integer type ‘Integer_t’, and the subroutine class ‘Subr_c’.

### Keywords

Table 1 below lists the keywords of the D language. Although these keywords as shown below are not enclosed in quotation marks, they can appear exactly as shown in the source code of a D language program.

TABLE 1
Keywords of the D Language

| | | | |
|---|---|---|---|
| abstract | extensible | namespace | struct |
| alias | final | net | switch |
| align | for | new | system |
| alloc | forward | newinit | thread |
| as | free | newran | type |
| at | friend | newvir | undef |
| begin | function | ordered | union |
| break | hardware | process | universal |
| case | if | ran | unordered |
| class | implements | randel | using |
| con | init | raninit | var |
| concrete | initdel | ranran | variant |
| continue | initinit | ranvir | vir |
| del | initran | remote | virdel |
| distinct | initvir | represents | virinit |
| do | inline | require | virran |
| else | interface | restricts | virvir |
| elsif | invariant | returns | volatile |
| end | life | rscheme | while |
| ensure | local | scope | |
| enum | method | select | |
| exit | module | shared | |
| extends | named | stable | |

### Literals

A literal is a token or token string representing the value of some object. In general, literals in the D language are of two constructions: lexical and syntactic. A lexical literal can be described entirely by a regular expression, and is represented in the grammar by a single terminal symbol. A syntactic literal is described by a context-free grammar, and is represented in the D language grammar by one or more non-terminal symbols. The lexical literals are described in this section.

Natural literals represents non-negative integers (that is, the natural numbers plus zero). Their token type is represented in the grammar by the terminal symbol NATURAL_LITERAL. They can come in several forms. The most basic form is a simple string of decimal digits, as in ‘123’.

To enhance readability, natural literals may include underscores in much the same way as commas and periods are sometimes used to group triplets of digits, as in ‘401_{—}105_{—}649’ for four hundred and one million, one hundred and five thousand, six hundred and forty-nine.

Natural literals may also include unsigned (non-negative) exponents, which are powers of the number base. Exponents are written as decimal numbers following ‘E’ or ‘e’ at the end of natural number literals. For example, ‘2E6’ or ‘2e6’ both mean 2 times 10 to the sixth power, or two million.

Number bases other than 10 (decimal) may be specified. Number bases are specified in decimal as natural numbers from 2 through 36, inclusive, and are followed by base digits enclosed in number signs ‘#’. Base digits are the decimal digits 0-9, and the letters A-Z and a-z. There is no significance to the case of the letters. For example, ‘16#5f#’ and ‘16#5F#’ represent the same hexadecimal number, which is the decimal number 95. These are called based natural literals. If based natural literals carry exponents, the exponents are powers of the number base. For example, ‘16#5f00#’ and ‘16#5f#e2’ represent the same number.

Natural literals never include a sign, and are always non-negative.

Floating-point literals are similar to natural literals, except that they may contain fractional digits to the right of a decimal point represented as a period ‘.’, and they may have negative exponents. Floating-point literals may also be based floating-point literals. For example, the floating-point literals 2.5 and 2#10.1# represent the same number. The type of floating-point literal tokens is represented in the grammar by the terminal symbol FP_LITERAL.

Character literals represents single characters from a character set. They consists of any single character enclosed in single quotation marks ‘′’. A quotation mark itself may be represented as a character literal by escaping it with a preceding backslash, as in ‘′\″’. A backslash may only be represented as a character literal by escaping it with another backslash, as in ‘′\\′’. The type of character literal tokens is represented in the granmar by the termiinal symbol CHAR_LITERAL.

String literals represents contiguous sequences of characters from a character set. They consists of a sequence of characters enclosed in double quotation marks ‘″’. A quotation mark itself may be represented in a string literal by escaping it with a preceding backslash, as in ‘″\″″’. A backslash may only be represented in a string literal by escaping it with another backslash, as in ‘″\\″’. The type of string literal tokens is represented in the grammar by the terminal symbol STRING_LITERAL.

If a character or string literal contains a backslash followed by a letter, as defined in Table 2 below, the two-character sequence represents the single indicated non-graphic character.

TABLE 2
Escape Sequences for Character and String Literals

‘\b’ BACKSPACE (BS)
‘\t’ CHARACTER TAB (HT)
‘\n’ LINE FEED (LF)
‘\v’ LINE TABULATION (VT)
‘\f’ FORM FEED (FF)
‘\r’ CARRIAGE RETURN (CR)

The operator characters are ‘!$%&*+−./:<=>?ˆ |˜’. Operator characters always combine with adjacent operator characters. However, only a certain set of such combinations are defined as operator symbols. This implies that, if two operator symbols are adjacent in the text, they must be separated by white space or other tokens.

Two operator symbols ‘′’ and ‘@’, never combine with each other or with adjacent operator characters. Note that ‘′’ is also a CHAR_LITERAL delimiter.

The operator symbols are as shown in Table 3 below. Although these operator symbols as shown below are not enclosed in quotation marks, they can appear exactly as shown in the source code of a D language program.

TABLE 3
Operator Symbols of the D Language

| | | | |
|---|---|---|---|
| ! | + | // | >= |
| != | ++ | //= | >> |
| !=== | += | /= | >>= |
| $ | − | : | <? |
| % | −− | :: | ? |
| %= | −= | := | ?> |
| & | −: | < | @ |
| && | −> | << | ˆ |
| &= | −>* | <<= | ˆ = |
| ′ | . | <= | \| |
| * | .* | =:= | \|= |
| ** | / | == | \|\| |
| **= | /% | === | ˜ |
| *= | /%= | > | |

### Grammar

Listing 1 is a listing of the grammar of the D programming language. This grammar is expressed in a modified Backus-Naur Form (BNF), in a form highly similar to that used as input to the parser generator Yacc, or any of the other similar parser generators readily available. The grammar is LALR(1), meaning that a LALR(1) parser generator can produce a parser for the language with no conflicts. The grammar itself is understood as follows.

Comments begin with two contiguous number signs ‘#’, and extend to the end of the line on which they appear. Comments have no effect on the meaning of the grammar.

Any identifier appearing on the left-hand side of an unadorned colon character ‘:’ is a non-terminal symbol of the grammar. By convention, non-terminal symbol identifiers are formed of upper- and lower-case letters, where the initial letter is always upper case, and the letter beginning each word or word fragment contained in the non-terminal symbol identifier is also upper case. All other letters in non-terminal identifiers are lower-case.

Any identifier never appearing on the left-hand side of an unadorned colon character is a terminal symbol of the grammar. By convention, terminal symbol identifiers are composed entirely of upper-case letters and the underscore character. All of the terminal identifiers of the grammar have been introduced in previous sections of this specification.

A string of one or more characters enclosed with single quotation marks ‘′’ is a terminal symbol, lexically formed by a sequence in the input of exactly the characters enclosed, or their upper- or lower-case equivalents, not including the enclosing quotation marks.

The grammar expresses a set of production rules. Each rule begins with a non-terminal symbol and an unadorned colon character. The colon is followed by a rule body. The rule is terminated by an unadorned semicolon character ‘;’. A rule body is one or more alternative production right-hand sides, each alternative separated by a vertical bar ‘|’ from adjacent alternatives. A production right-hand side is a sequence of terminal and/or non-terminal symbols to be found in the input.

The start symbol of this grammar is Statements.

Overall, the grammar of the D language is very similar to that of C++, with important differences highlighted in the following sections. In the following sections, occasional reference will be made to the identifiers of non-terminal symbols as they appear in the grammar. These identifiers can be recognized by their lexical form, that is, the unique combination of upper- and lower-case letters described above.

### Fundamental Concepts and Terminology of the D Language

Unlike other programming languages, the D language distinguishes type from class, and has a more abstract definition of type, as well as slightly different understandings of classes and their relationships. Understanding these distinctions is key to understanding the novel aspects of the D language.

The D language defines the term “type” to be purely “a distinct set of values”, without any association with classes, methods or operations, data structures, or default or implicit implementations. A D language type is therefore abstract, meaning that it cannot be implemented directly. This is not to prevent a type in D from being used to designate a set of values representable by an object of a class. However, a class whose objects represent values of a type, and the representation relationship from the class to the type, are specified separately from the class or the type, as will be seen later below.

Types are defined in the D language using TypeLiterals, and can be named in NewStatements. Listing 2 is the description in the D language of the intrinsic types of the D language. These types are intrinsic to the language in the sense that, although they can be defined in source code conforming to the language, their definitions as given in Listing 2 must be assumed by the compiler.

Number types are introduced on lines 18-21 of Listing 2. Each number type is declared an ordered type, meaning that there is a full or partial ordering relation between any two values of the type. Without the designation ‘ordered’, a type's values are assumed to be unordered. A type may be declared a supertype of another type by use of the ‘extends’ clause. The type mentioned in the ‘extends’ clause is the subtype of the type whose definition contains the ‘extends’ clause. Thus, the D language intrinsic numeric types reflect exactly the mathematical understanding of real numbers: the type ‘Natural_t’ is the set of natural or counting numbers, including zero; the type ‘Integer_t’ is the superset of ‘Natural_t’ which includes the negatives of the natural numbers; the type ‘Rational_t’ is the superset of ‘Integer_t’ incorporating all those numbers which can be represented by a ratio of two integers (where the denominator is not zero); and the type ‘Real_t’ is the superset of ‘Rational_t’ incorporating the irrational numbers.

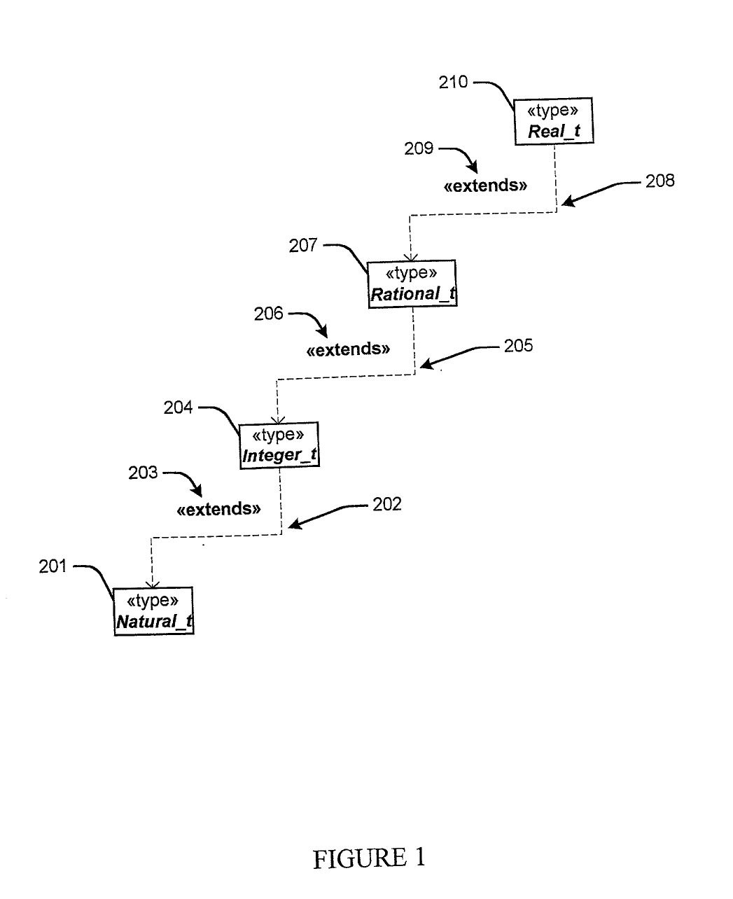

These types and their relationships are also represented graphically in FIG. 1, using the graphical symbols of the Unified Modeling Language (UML), as defined by Rumbaugh, James, Ivar Jacobson, and Grady Booch, “The Unified Modeling Language Reference Manual,” Reading, Mass., Addison-Wesley, 1999, which is incorporated herein by reference.

The type ‘Natural_t’ is represented by the box 201. This box 201 is the UML symbol for a class. However, using UML notation, this symbol for class is restricted by a stereotype, which is the word <<type>> in guillemets at the top of the box 201. In the UML, stereotypes are variations of existing model elements with the same form but with a different intent.

It is important to keep in mind that the UML defines a type as a stereotype of a class, but that is not at all true in the D language. In fact, a novel aspect of the D language, already mentioned above, is that a type is a purely abstract entity, and is not a class or any stereotype of a class. The UML notation is borrowed for FIG. 1 because it is the only industry standard notation available for illustrating most of the other object-oriented concepts of the D language. However, in the use of UML for illustrating D language concepts, it will occasionally be necessary to modify the meaning of the graphical symbols, as is done here.

The type ‘Integer_t’ is represented by the box 204, and its supertype relationship to ‘Natural_t’ is indicated by the dashed arrow 202 to the box 201. The UML defines this dashed arrow 202 as illustrating a dependency relationship; that is, the type ‘Integer_t’ depends on the type ‘Natural_t’. The nature of the dependency is further qualified by a UML stereotype, namely the word <<extends>> in guillemets 203 positioned above the dashed arrow 202. Note that the direction of the arrow reflects the direction of reference in the D language source code in Listing 2. In other words, since the definition of ‘Integer_t’ in Listing 2 contains a reference to ‘Natural_t’, the arrow 202 points from ‘Integer_t’ 204 to ‘Natural_t’ 201.

In like manner, the type ‘Rational_t’ is represented by the box 207, and its supertype relationship to ‘Integer_t’ is indicated by the dashed arrow 205, qualified by the word <<extends>> 206, to the box 204. The type ‘Real_t’ is represented by the box 210, and its supertype relationship to ‘Rational_t’ is indicated by the dashed arrow 208, qualified by the word <<extends>> 209, to the box 207.

The UML defines stereotypes appearing in guillemets above lines showing relationships as applying to those relationships. These stereotypes have been called out separately in FIG. 1 in order to enhance the understanding of those unfamiliar with the UML. In FIGURES other than FIG. 1, such stereotypes will not be called out separately.

All of the sets shown in FIG. 1 are infinite and therefore cannot be represented on any finite computer, but they can nonetheless be named in the D language. It should be noted that the infinite type ‘Rational_t’ is the supertype of any finite numeric type which can be represented on any finite computer.

These types and their relationships are important to the D language compiler primarily so that it has rules for the substitution of values. A value of a subtype may always be used in place of a value of its supertype; the reverse is not always true. The importance of these relationships will become more apparent as compilation methods are described below.

These types are named in NewStatements, which, unsurprisingly, begin with the keyword ‘new’. NewStatements introduce new objects in the current lexical scope. The NewStatements on lines 18-21 of Listing 2 identify objects already built into the D language compiler, representing the types named.

NewStatements do not imply anything about allocation or memory management. In particular, the keyword ‘new’ does not imply heap allocation, nor does it imply automatic garbage collection. As will be seen later on, before the D language compiler can compile a NewStatement to generate code to create an object at run time, allocation must be explicitly specified for that object by an AtClause or AtStatement.

Note also that the names of the intrinsic types are not keywords, but rather are predefined identifiers. They are not keywords because there is no special provision for them in the lexicon or grammar of the language. The suffix ‘_t’ is purely conventional, as are all suffixes used in identifiers.

In Listing 2, after the definitions of the numeric types the types ‘Character_t’ and ‘Bool_t’ are defined. ‘Character_t’ represents the set of all values used to represent two-dimensional characters used in written human communication, together with all values intermixed with those values in computer communication. In other words, ‘Character_t’ is the supertype of all computer character sets.

‘Bool_t’ is the Boolean type, having exactly two values, ‘false’ and ‘true’. An instance of an EnumLiteral appears on line 37 of Listing 2, enumerating, or naming, these two values. An EnumLiteral does nothing more than give names to the values of a type. Note that the type ‘Bool_t’ is unordered, and that EnunLiteral has no implicit implementation. An EnumLiteral states nothing implicitly or explicitly regarding possible representations of values of a type.

The NewStatement containing the EnumLiteral on line 37 defines a new object identified as ‘Bool_e’. This is the object, already built into the D language compiler, which represents the enumeration defined here.

Number types useful in binary computers with 8-bit bytes are introduced starting on line 44 of Listing 2. Although these are still abstract types (because they are D-language types), their identifiers imply that they represent sets of values commonly represented in present-day computers.

The first such number type is ‘Nat128_t’. ‘Nat128_t’ is the set ofnatural numbers (including zero) representable in binary form in a 128-bit memory word, that is,

0 through +2¹²⁸−1

Note that this numeric range is nowhere specified in Listing 2. The range is associated with the identifier ‘Nat128_t’ by the definition of the D language. The D language compiler assumes this range is associated with this type identifier.

Note, in Listing 2, that ‘Nat128_t’ is defined in a NewStatement containing a ‘restricts’ clause. This clause specifies a subtype/supertype relationship with the same meaning as that specified in an ‘extends’ clause, but in the opposite direction. Thus, ‘Nat128_t’ is defined as a subtype of ‘Natural_t’.

Natural number types are consecutively specified in Listing 2 for common implementation sizes, as subtypes of the preceding types, down through an 8-bit natural number, ‘Nat8_t’, defined on line 48. Each type has associated with it by definition of the D language a corresponding numeric range as implied by its identifier.

The definitions of the integer types begin with ‘Int128_t’ online 50 of Listing 2. This type is the set of integers representable in binary 2's complement form in a 128-bit memory word, that is,

−2¹²⁷ through +2¹²⁷−1

The definition of ‘Int128_t’ contains both a ‘restricts’ clause and an ‘extends’ clause, showing that subtype/supertype relationships in both directions may be specified in a type definition. In this case, an ‘Int128_t’ is defined as a supertype of ‘Nat64_t’, because every natural number occurring in the set identified by ‘Nat64_t’, without exception, occurs in the set identified by ‘Int128_t’ as well. By the transitivity of the subset relation, every value occurring in every subtype of ‘Nat64_t’ also occurs in ‘Int128_t’. The knowledge of a hierarchy of subtype/supertype relationships assists the D language compiler in preserving correctness as it makes decisions regarding the implicit conversions of values from one type to another. This mechanism will be explored in detail below.

The ability to specify both subtypes and supertypes in a type definition allows future type definitions to be “sandwiched in” between prior definitions, without modification of those prior definitions. This enables programmers to extend types defined in a library supplied by an external organization, without necessitating modification to that library, which may be impractical if the external organization is unable or unwilling to make those modifications. For example, a type representing 48-bit binary 2's complement integers could be defined as ‘new ordered type restricts(Int64_t) extends(Int32_t) Int48_t; Because of the transitivity of the subtype relation, ‘Int48_t’ is thus defined as the supertype of ‘Int32_t’ and all of its subtypes, and the subtype of ‘Int64_t’ and all of its supertypes. This new definition is accomplished without modification of the source code defining those types referenced.

Listing 2 continues with definitions of binary 2's complement integer types, down through ‘Int8_t’, the type of the set of integers representable in an 8-bit byte.

Following the integer types are the floating-point types. Each of these identifies the set of values representable by a binary representation of a floating-point number. The types ‘Float32_t’, ‘Float48_t’, ‘Float64_t’, and ‘Float80_t’ mustberepresentedby implementations of the IEEE Standard for Binary Floating-Point Arithmetic which uses the number of bits implied by the type identifier. The IEEE Standard for Binary Floating-Point Arithmetic is defined by The Institute of Electrical and Electronics Engineers, Inc., “IEEE Standard for Binary Floating-Point Arithmetic,” IEEE Std 754-1985, New York: IEEE, 1985, and is incorporated herein by reference. The type ‘Float128_t’ is an extension of the formats defined in the IEEE Standard for Binary Floating-Point Arithmetic.

Again, both subtype and supertype relations are defined. It is important to note that an integer type defined as a subtype of a floating-point type is the largest type all of whose values can be represented exactly in the floating-point type. If any of the values of an integer type could be converted to a floating-point type, but with either a possible loss of precision or a possible overflow, that integer type cannot be defined as a subtype of the floating-point type. The interpretation of the subtype relation is strict in the D language. An inexact conversion from one numeric format to another is called exactly that, a conversion.

These numeric types presented so far are intrinsic to the D language in order to standardize implementations of the language on present-day computers. However, it is conceivable that a variant of the language could be defined with different types defined at this point, without invalidating anything defined prior to this point. This would be important for computers with other than 8-bit bytes.

The final types defined in Listing 2 relate to the Unicode character set. Unicode is the international standard for representing most characters used in human and computer communication, as defined in Unicode Consortium, “The Unicode Standard, Version 3.0”, Reading, Mass., Addison-Wesley, 2000, which is incorporated herein by reference.

The identifier ‘Unicode_t’ identifies the set of values represented by the Unicode character set. The subset of those values of most relevance to the D language is the “character block” labeled by the Unicode standard as Basic Latin, and identified in the intrinsic types as ‘BLatin_t’. (These 128 characters are identical to those defined in the ASCII character set.) All of the tokens of the D language can be expressed in the characters of the Basic Latin character block.

As can be seen in Listing 2, the values of the ‘BLatin_t’ type are enumerated in an enumeration identified as ‘BLatin_e’. This EnumLiteral shows that an enumeration value name can be a character literal as well as an identifier. Since ‘BLatin_t’ is an ordered type, the order of the enumeration value names in the EnunLiteral is presumed to be the same as the order of the values in the type.

### Representation of Type Values

In keeping with the object-oriented approach, the D language defines a class as a descriptor for a set of objects that share the same attributes, structure, operations, methods, relationships, and behavior. Further, the D language defines an interface as a descriptor of the externally visible attributes, operations, relationship, and behavior of a class of objects. In the D language, only those features of a class exposed through an interface can be observed or invoked by code written outside of that class implementation. This last fact accomplishes encapsulation, an essential element of an object-oriented programming language.

An interface represents a contract between a class, which provides services, and any software outside that class, which consumes services. A class implements an interface, by providing the mechanisms to accomplish the contract represented by that interface. A class provides an internal data structure and methods to operate on the data structure, in order to meet the requirements of an interface it implements. This is typical of current object-oriented programming languages, such as Java®.

However, in keeping with the concept of abstract type given above, which is not normally part of the definition of an object-oriented programming language, the D language embodies the point of view that object, described by classes, represents values of types by mapping the values of types to their states. The relationship between types and classes whose objects represent their values in their states is defined in the D language through class interfaces. In the D language, an interface represents a type.

Just as there are types which are intrinsic to the language, there are interfaces which are intrinsic to the language. These include interfaces representing the intrinsic types. Since the numeric type interfaces are highly similar to one another, only four of them have been selected for presentation here, in order to illustrate the concept of an interface representing a type, and to show the relationships which thereby arise among interfaces and types. The interfaces presented are the interfaces representing the leaf-most subtypes of each infinite numeric type: the ‘Nat8_i’, ‘Int8_i’, ‘Int16_i’, and ‘Float32_i’ interfaces.

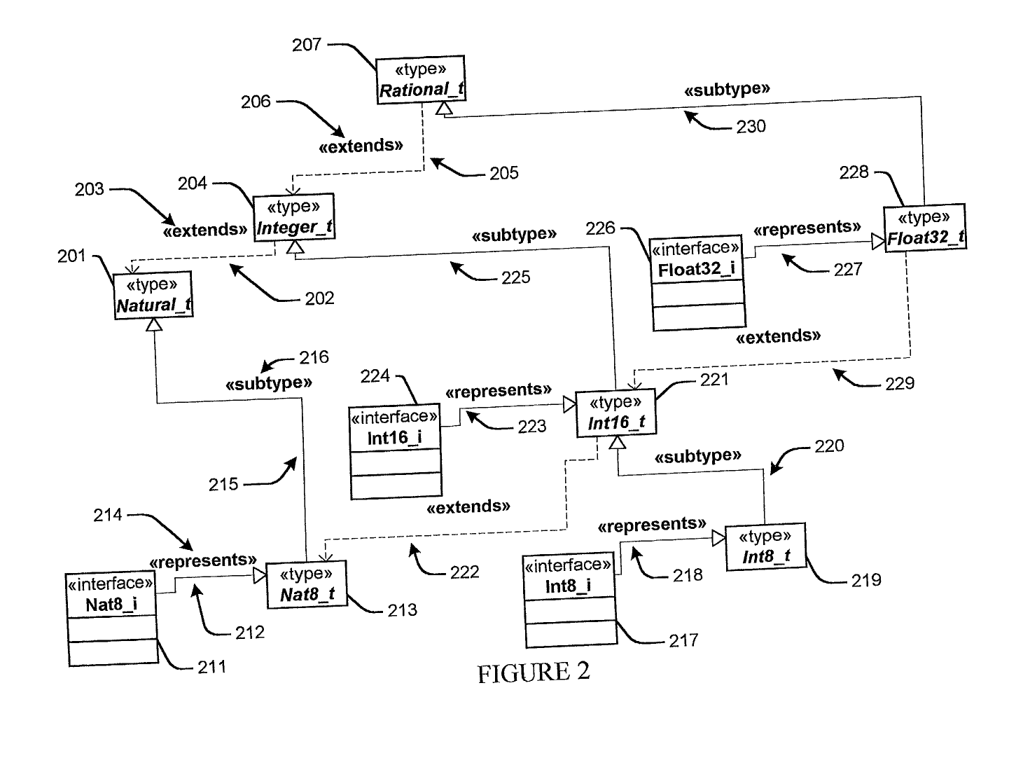

FIG. 2 is a UML diagram showing the four interfaces just mentioned, their relationships to the four types they represent, the relationships between those four types, and, for reference, the relationships of those four types to the infinite types shown in FIG. 1.

Box 211 of FIG. 2 is the standard UML notational element that depicts a class interface. It uses the box representing a class, containing at its top the stereotype <<interface>>. Box 211 is labeled ‘Nat8_i’, the name of the interface represented by the box. The solid arrow 212 leading from the interface ‘Nat8_i’ 211 has an open arrowhead. This is the standard UML notational element showing a generalization relationship, in this case from interface ‘Nat8_i’ 211 to type ‘Nat8_t’ 213. The arrow 212 is qualified by a non-UML stereotype, the word <<represents>> in guillemets 214 above the arrow 212.

The type ‘Nat8_t’ 213 is a subtype of the infinite type ‘Natural_t’ 201. Note, however, that although the D language ‘extends’ clause is represented by a stereotype <<extends>> on a dependency arrow, as 203 and 202 show respectively, the D language ‘restricts’ clause is represented by the stereotype <<subtype>> on a generalization arrow, as 216 and 215 show respectively, and not by a stereotype using the keyword ‘restricts’. This is because the UML already has the notion of a subtype relationship, and its notation is used here, though as mentioned above, the UML does not have the notion of a purely abstract type, as defined in the D language. Again, the direction of the arrowhead indicates the direction of the reference in the text. However, there is a difference between the depiction of the subtype relationship by arrow 215 in FIG. 2, and the D language statements in Listing 2 defining ‘Nat8_t’. The listing shows many intermediate types between the type ‘Nat8_t’ and its eventual supertype ‘Natural_t’. These details are subsumed by the generalization arrow 215 without any loss of correctness, since ‘Nat8_t’ is indeed a subtype of ‘Natural_t’.

It can be seen that box 217 of FIG. 2 shows interface ‘Int8_i’, and that the generalization arrow 218 shows that it represents type ‘Int8_t’ 219. Type ‘Int8_t’ 219 is a subtype of type ‘Int16_t’ 221, as shown by generalization arrow 220. Type ‘Int16_t’ 221 is a supertype of type ‘Nat8_t’ 213, as shown by dependency arrow 222. Type ‘Int16_t’ 221 is represented by interface ‘Int16_i’ 224, as shown by generalization arrow 223. Type ‘Int16_t’ 221 is shown to be a subtype of type ‘Integer_t’ 204 by generalization arrow 225. Again, this arrow 225 elides intermediate types without losing correctness.

Interface ‘Float32_i’ 226 represents type ‘Float32_t’ 228 as shown by generalization arrow 227. ‘Float32_t’ 228 is shown as a supertype of type ‘Int16_t’ 221 by dependency arrow 229, and as a subtype of type ‘Rational_t’ 207 by generalization arrow 230, which again elides intermediate types.

Thus, FIG. 2 depicts, using standard UML notation with extensions relating to pure abstract types, the subtype/supertype relations between certain types, and the representation relations from certain interfaces to some of these types. Listing 3 shows the D language definitions of the interfaces depicted in FIG. 2.

### Initialization

Before examining Listing 3, some notes on syntax are requisite. A NewStatement, as indicated by the grammar in Listing 1, can take several forms. One form consists of the keyword ‘new’, an expression giving the class of an object about to be introduced, the new identifier itself, and an expression in parentheses used to initialize the object immediately after its creation. For example, assuming the class ‘Int32_c’ is defined, the statement ‘new Int32_c x (43);’ defines a new object of class ‘Int32_c’, and initializes it to the value 43.

The D language makes a careful distinction between initialization and assignment. After an object is allocated, no methods may be invoked on it until an initialization method has been invoked. The D language reserves the term “construction” for the combination of allocation and initialization.

A class defines zero or more initialization methods, which may be exposed through interfaces implemented by the class. An initialization method is defined in a class or interface literal either by naming it with the special identifier ‘initialize’, or by declaring its dataflow attribute to be ‘virinit’ (more on dataflow attributes later). An initialization method named ‘initialize’ may be invoked as in the example above, by following the object identifier with a list enclosed in parentheses of zero or more actual argument expressions. An initialization method named other than ‘initialize’ may be invoked by name in the usual manner for method invocation.

Assignment is the copying of a value to an already initialized object. Assignment methods have no different status than other methods which operate on initialized objects.

As an example, assume that the class ‘Int32_c’ is defined with an ‘initialize’ method that takes no arguments (a so-called default initializer), an ‘initialize’ method that takes one argument of class ‘Int32_c’ (a so-called copy initializer), and an ‘assign’ method (which can be invoked with the assignment operator ‘:=’). The following code fragment in the D language, shown below without enclosing quotation marks, illustrates the use of ‘initialize’ methods and syntax:

| | |
|---|---|
| new Int32_c x; | ## an uninitialized object |
| x:=5; | ## error--x not yet initialized |
| x (6); | ## initialization |
| x:=7; | ## assignment is OK now |
| new Int32_c y (x); | ## an object initialized by copying |
| new Int32_c z (); | ## an object initialized by default |
| z (23); | ## error--z already initialized |
| new Int32_c a:=9; | ## syntax error--assignment syntax not accepted |

One can see on line 19 of Listing 3 the definition of the ‘Nat8_i’ interface in a NewStatement. This NewStatement introduces the identifier ‘Nat8_i’ as a new identifier for an object of class ‘Interface_c’. The identifier ‘Nat8_i’ is immediately followed (on the next line of the listing) by an opening parenthesis. The matching closing parenthesis is on line 176. The closing parenthesis is immediately followed by a semicolon. This semicolon ends the NewStatement.

The contents of the parentheses form a ClassifierLiteral for a classifier named ‘interface’. The value expressed by this lengthy literal is used to initialize the new object named ‘Nat8_i’. This syntax is significant, because it demonstrates that the D language treats a literal expressing an interface as a value in the same way it treats a literal expressing a number as a value. Likewise, it treats an object of class ‘Interface_c’ (the parameterized meta-class of interfaces in the compiler) in the same way it treats an object of any class. The syntax of the D language directly supports the manipulation of objects representing classes, interfaces, and types, through methods defined by their classes, just as any object-oriented language supports the manipulation of user-defined objects through methods defined by user-defined classes. This uniformity of syntax extends to the meta-classes describing class descriptor objects themselves; in fact, it extends to every object involved in compiling a D language program. This has significance for the novel method of compilation described below. This information is presented here so that one can understand that the syntax for associating an identifier with an interface literal is the same as the syntax for initializing an object with a value.

The interface literal beginning on line 20 of Listing 3 begins with a clause indicating that it represents the ‘Nat8_t’ type. This means that each value of the ‘Nat8_t’ type can be mapped to a state of an object of a class implementing this interface. Through multiple represents clauses, a single interface can represent multiple types. If an interface literal has no represents clause, then it is taken to represent an unspecified anonymous type which is different from all other anonymous or identified types in any source code. In other words, every interface literal with no represents clause implicitly defines a new, unique anonymous type. Two interfaces which have no represents clauses represent two different types.

### Interface Literals

In the example of interface ‘Nat8_i’ in Listing 3, every member declaration is of the syntactic category ModifiedClassifierMemberSpec, and begins with one of the keywords ‘method’ or ‘function’. Methods are member routines which can modify the state ofthe current object; function are member routines which cannot modify the state. Routines of either type, however, can modify their arguments, if that is allowed by their formal argument specifiers, and/or can return values as results to be used in expressions which invoke them.

The identifier ‘Subr_c’, first seen on line 22 of Listing 3, is another identifier whose meaning is predefined by the D language. It is the class of subroutine objects. More specifically, it is a parameterized abstract base class which describes all objects which can equivalently be invoked by a subordinating control transfer (a call), or placed inline at the point of their invocation, with appropriate argument substitution. Thus, an instance of a class ‘Subr_c’ is a subroutine. Argument substitution is explained in detail in a later section.

As mentioned, ‘Subr_c’ is a parameterized class. This means that ‘Subr_c’ alone is not a class, but ‘Subr_c’ taken together with some arguments is a class. ‘Subr_c’ takes one argument, which is an object representing a subroutine's formal arguments. It is readily apparent from the grammar of Listing 1 that the digraphs ‘<?’ and ‘?>’ delimit FormalArguments. The correct way to read the expression ‘Subr_c<? ?>’ is “the invocation of an ‘initialize’ method of an object identified as ‘Subr_c’, said ‘initialize’ method taking a single argument, of class ‘FormalArgs_c’, representing no formal arguments”. The resultant object is a class of subroutines which take no arguments. An object of this class is a subroutine. A subroutine object is initialized with the value of a statement block, typically by providing a StatementBlock literal in the source code, which is a series of Statements enclosed in curly braces ‘{}’.

Once again, several aspects of the implementation of the D language are exposed in object-oriented terms. ‘Subr_c’ is an object which is a parameterized class. The formal arguments to a subroutine are represented as an object, of class ‘FormalArgs_c’. A class of subroutines can be declared based on the formal arguments they take, by initializing an instance of ‘Subr_c’ with an object of ‘FormalArgs_c’. Finally, an object of the class so created can be initialized with a literal value, just as any other object in the language can be initialized. This externalization is key to the novel method of compilation described later. Understanding these concepts now will be helpful in interpreting the interface literals in Listing 3.

### Ensure and Require Clauses

Most of the methods in the interface literal include EnsureClauses. EnsureClauses contain Boolean expressions expressing post-condition of methods, that is, conditions which methods guarantee to be true after their execution. EnsureClauses are useful during debugging, as the D language compiler can be directed to generate code to test the truth of EnsureClauses after methods execute.

The syntactic category EnsureClause is part of the syntactic category FormalArguments. EnsureClauses form part of the state of objects of class ‘FormalArgs_c’, and therefore affect overloading and implementation. Specifically, a class method implementing an interface method must have EnsureClauses specifying the same or stronger post-conditions than those specified by the interface method being implemented.

RequireClauses, not used in Listing 3, contain Boolean expressions expressing pre-conditions of methods, that is, conditions which must be true before their execution. Like the syntactic category EnsureClause, the syntactic category RequireClause is part of the syntactic category FormalArguments. Also like EnsureClauses, RequireClauses form part of the state of objects of class ‘FormalArgs_c’, and therefore affect overloading and implementation. Specifically, a class method implementing an interface method must have RequireClauses specifying the same or weaker pre-conditions than those specified by the interface method being implemented.

### Explicit Conversions

Lines 22 and 24 of Listing 3 define initialization methods named with the predefined identifier ‘initialize’, and so can be called using the initialization syntax described above. Lines 29-46 of Listing 3 define methods named ‘convert’ (not a predefined identifier) with dataflow attribute ‘virinit’. These are initializer methods that must be invoked by name. The reason for the distinction is the following. The language assumes that an ‘initialize’ method which takes exactly one argument, and that argument is of a different interface than that of which the method is a member, is an initializer which can be used to implicitly convert from an object conforming to the argument interface to an object conforming to the interface of which the ‘initialize’ method is a member (assuming there are no type conflicts, as described below). The compiler uses this fact to properly evaluate arithmetic expressions containing objects representing (through their interfaces) numeric types of mixed sizes. The compiler generates code which implicitly, and without warning, uses these ‘initialize’ methods to convert objects from one numeric format to another. Thus, only those conversions which do not possibly truncate or round their results, nor possibly overflow, are defined in the intrinsic classes using the predefined name ‘initialize’.

Another safeguard in numeric conversions is the type information connected to the intrinsic interfaces. By definition, a value of a type may be used as a value of its supertype, so a conversion from an object representing a type to an object representing a supertype of that type is always permissible, and may be implicit. The reverse conversion, from an object representing a type to an object representing a subtype of that type, may be valid if the value in question is a value of the subtype, but it cannot be made implicitly by the compiler. These rules apply not just to the intrinsic numeric types and interfaces, but to all types and interfaces defined in a D language program. That is why the D language compiler does not make the mistake of converting an object of ‘FormalArgs_c’ to an object of ‘Subr_c’, even though ‘Subr_c’ includes an ‘initialize’ method taking one argument of class different from itself: the classes represent different types.

As the numeric type ‘Nat8_t’ is the smallest set of natural numbers in the D language, there are no implicit conversions to it possible, so the interface literal in Listing 3 which initializes ‘Nat8_i’ contains no definitions of implicit conversions. Larger numeric types shown later in Listing 3 define implicit conversions using the ‘initialize’ predefined identifier.

Arithmetic in the D language is completely safe and correct, as ensured not only by the control exercised over numeric conversions as just described, but also by the following rules.

Every class implementing an intrinsic interface representing a numeric type must implement its operations following the usual arithmetic rules. Integers and natural numbers are not treated as numbers modulo their underlying representation's size. If a result of an operation on an object cannot be expressed in the type represented by the object, an exception must be thrown. This includes overflow, and negative results on natural numbers. Operations on floating-point numbers are as defined by the IEEE Std 754.

As an example, consider the so-called shift left operation, represented by the predefined identifier ‘shiftLeft’. This operation takes its name from the underlying hardware implementation common on binary computers, namely shifting the bits of a binary integer to the left in order to increase its value. However, the operation is defined arithmetically, not physically, as a scaling operation. A shift left of n increases the magnitude of a binary number by 2ⁿ, and preserves the sign. For instance, a shift left of a binary 2's complement integer never changes the value of the sign bit. Additionally, if the result of a shift left cannot be represented in the type of the class of the object being operated upon, an exception is thrown. For instance, if a bit is shifted out of the high-order bit position just before the sign bit of a binary 2's complement integer, and that bit is not equal to the sign bit, an overflow occurs and an exception is thrown.

What is significant about the rules surrounding the intrinsic numeric interfaces is that they are constrained by the subtype/supertype relationships among the types these interfaces represent.

### Formal Argument Literals

It has already been shown that empty formal argument delimiters ‘<? ? >’ represent no arguments whatsoever. The most common form of formal argument literal that appears in Listing 3, besides the empty literal, has one formal argument specifier, or two formal argument specifiers separated by a comma. Each argument specifier has three or four components: an optional keyword ‘returns’, one of the optional keywords ‘con’ or ‘var’, an expression signifying an interface, and a formal argument identifier. A formal argument marked ‘returns’ signifies that the corresponding actual argument may be used as the value of the expression which invokes the subroutine. This is how operator symbols return values, as will be seen shortly. The keyword ‘con’ or ‘var’ indicates that the subroutine invoked may not or may modify the corresponding actual argument, respectively. In their absence, the default is ‘con’, unless the formal argument is marked ‘returns’, in which case the default is ‘var’.

### Constant and Variable Classes

D language interface literals implicitly define two interfaces simultaneously. Likewise, D language class literals implicitly define two classes simultaneously. An interface literal defines one interface as including as members all initializer and finalizer methods, and all functions, defined in the literal. This is an interface to a constant class, as it contains no methods that can modify the state of an object after initialization or before finalization. If the same interface literal contains methods other than initializers and finalizers, then it simultaneously defines a second interface as including as members all methods and functions defined in the literal. This is an interface to a variable class, as it contains methods that can modify the state of an object after initialization and before finalization. These rules apply equivalently to class literals.

As variable interfaces or classes contains exactly the same data members and functions as the constant interfaces or classes with which they are defined, and a superset of the methods of the constant interfaces or classes with which they are defined, the D language considers a variable interface or class to be directly derived from the constant interface or class with which it is described.

A reference to an object initialized by an interface or class literal may be explicitly qualified by the keyword ‘con’ or ‘var’, or it may be left unqualified. If qualified by the keyword ‘con’, the base constant class is referenced. If qualified by the keyword ‘var’, the derived variable class is referenced. If unqualified, the meaning is defined by the context of the reference. For instance, the class expressions of formal argument specifiers are implicitly qualified with ‘con’, except that a formal argument marked ‘returns’ is implicitly qualified with ‘var’.

The rules for substituting references to objects of a variable class for references to objects of a constant class are exactly the rules that apply for substituting references to objects of a derived class for references to objects of a base class. Specifically, a reference to a variable class may always be substituted for a reference to a constant class, but the reverse is not true.

### Operator Symbols

Studying the interface literals in Listing 3, one can see comments associated with many of the member methods and functions, near the right-hand margin, showing operator symbols such as ‘++’ and ‘:=’. These comments serve to remind the reader that the D language defines a fixed mapping between operator symbol lexical tokens and predefined member subroutine identifiers. The D language also predefines fixed operator precedence rules, and fixed associativity, commutativity, and distributivity rules based on those normally used in arithmetic, so that the following three statements, shown below without enclosing quotation marks, are all semantically equivalent to each other:

d:=a+b*c;

d:=(a+(b*c)

d.assign(a.sumOf(b.productOf(c)));

Thus, every expression in the D language can be deterministically converted to a series of predefined method and/or function calls, without reference to user-defined classes, interfaces, or types. Once this conversion is complete, overload resolution, as described below, can begin.

### Overloading

Overloading is a programming language feature wherein a single identifier for a subroutine is used to define more than one subroutine. Subroutines identically named are distinguished by the number and classes of their formal arguments. In D language terms, if two or more instances of classes of ‘Subr_c’ are identified with the same identifier, but each is parameterized with differing formal arguments, that identifier is said to be overloaded. When an overloaded identifier is used in a source program text, the D language compiler resolves the identifier to refer to a particular subroutine object by matching the number and classes of actual arguments supplied to the patterns of formal arguments declared with each subroutine definition using that identifier. If the number and classes of actual arguments supplied exactly matches the number and classes of formal arguments supplied in one definition of an instance of ‘Subr_c’ identified by the overloaded identifier used, then the overloaded identifier is interpreted to refer to the corresponding instance of ‘Subr_c’. If the compiler cannot exactly match the number and classes of actual arguments supplied with a reference to an overloaded identifier with any pattern of formal arguments declared with that identifier, it may use conversion ‘initialize’ methods plus type information to make conversions which facilitate overload resolution. If the compiler could legally choose more than one version of a subroutine identified with an overloaded identifier, the compiler is free to choose any one of them, arbitrarily and non-deterministically.

Conversion of operator symbols in expressions to invocations of predefined subroutine identifiers is done before overload resolution. Thus, operator symbols may be overloaded by overloading the predefined identifiers to which they map.

### Expression of a Computer Architecture

Traditional object-oriented programming ignores the descriptions of the physical objects of computers as containing details too trivial to be relevant to the production of an object-oriented program. The D language takes a novel departure from the object-oriented approach by describing with classes the software-visible objects that hold state in a computer. Concrete classes in the D language (those in which no aspects are subject to further interpretation) exactly describe objects in computers, including both their structures and the methods by which their states may be altered. The D language describes physical objects in computers, namely memory cells, registers, and other state-holding mechanisms, as a pre-existing global objects which may be said to represent the values of types by mapping each of their states to values of the types represented.

The application instruction sets of most computer architectures are oriented primarily toward manipulating the states of registers, and copying their states to and from main memory. From an object-oriented programming viewpoint, registers and main memory are the fundamental physical objects of a computer. Unlike other object-oriented programming languages, the D language makes it possible to write classes describing registers and main memory, and to represent computer instructions as methods of those classes. These descriptions are exact, concrete, and complete, so that the D language can be used as an assembly language for computer architectures.

In the general terms of object-oriented analysis and design, the task of designing classes to describe any physical objects, be they in a computer or elsewhere, is an exercise in the art of software engineering. As there are many ways to accomplish the desired goal, judgments must be made based on heuristics established in practice and the skill and knowledge of the practitioner. The classes presented below are the preferred implementation of a description of a particular computer architecture. It must be kept in mind that these classes are presented both to teach more about the D language, specifically about its features which allow the describing of a computer, and to teach how to apply the D language, using the arts of object-oriented analysis and design, to describe any computer architecture using classes written in source code in the D language.

The primary goal of an object-oriented description of a computer architecture is to encapsulate as far as possible each class of object in a computer. To accomplish this, the heuristic is used that most if not all of the instructions in a computer's instruction set which modify a given class of objects should be made methods of that class. For example, an instruction which copies the state of a register to memory should be a method of a memory class, while an instruction which copies the state of a memory cell to a register should be a method of a register class. Instructions which modify more than one class of object cannot be dealt with using this simple heuristic. Based on other considerations, such instructions can be made methods of one of the classes whose objects they modify, they can be made methods of a new class at a slightly higher abstraction level than those representing computer hardware objects directly, or they can be represented as global subroutines, not methods of any class.

The Intel® Architecture for 32-bit computers, also referred to herein simply as the Intel® Architecture, will be used to illustrate the D language. (Intel® is a registered trademark of Intel Corporation.) However, descriptions can be built in the D language for any von Neumann computer architecture currently available today in commercial computers.

The Intel® Architecture resulted from the extension of an original 16-bit architecture to a 32-bit architecture. The resultant architecture is Byzantine, and not straightforward to describe in any medium. Nonetheless, the D language successfully describes all aspects of this architecture.

### Application Programming Registers

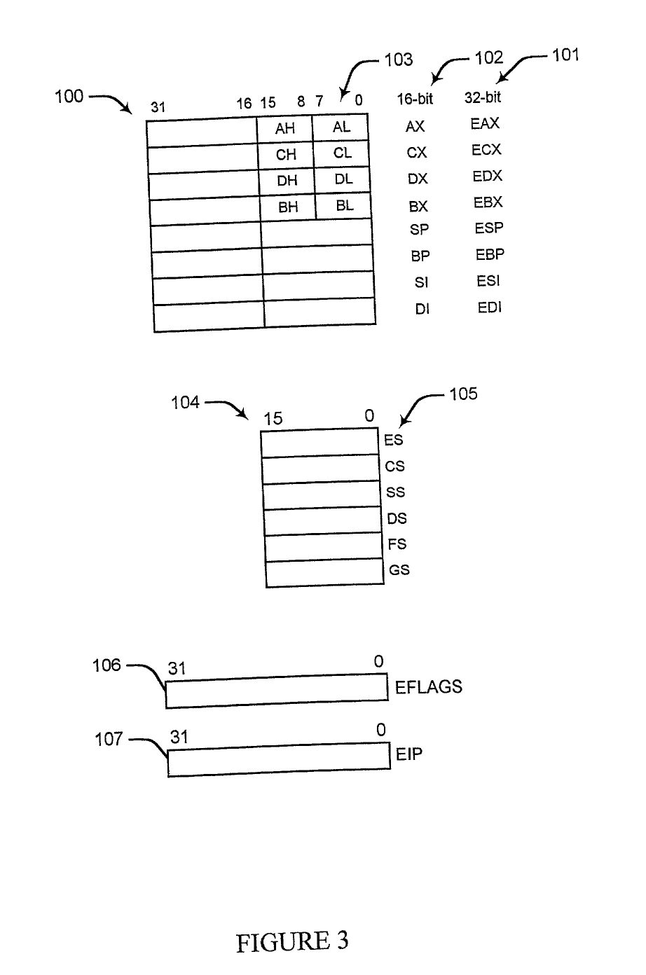

FIG. 3 is a pictorial representation of the so-called Application Programming Registers in the Intel® Architecture for 32-bit computers. This information is derived from Intel Corporation, “Intel® Architecture Software Developer's Manual, Volume 1: Basic Architecture”, Santa Clara, Calif.: Intel Corp., 1999, which is incorporated herein by reference. The eight 32-bit general-purpose registers of the Intel® Architecture are represented by a group of eight boxes 100, each named as indicated in the corresponding row of the column 101 headed “32-bit”. The low-order 16 bits of each of these eight registers are separately addressable, and each 16-bit portion is named as indicated in the corresponding row of the column 102 headed “16-bit”. The low-order 16 bits of the first four registers are addressable in 8-bit units, and each 8-bit portion is named as indicated within the eight boxes 103 representing those units. The numbers positioned above the boxes 100, which are 0, 7, 8, 15, 16, and 31, represent bit position numbers. By definition of the Intel® Architecture, bit 0 is the rightmost and least-significant bit, and bit 31 is the leftmost and most-significant bit. The convention of numbering bits in this order, starting with the least significant bit, is called little endian.

FIG. 3 also shows the six 16-bit segment registers of the Intel® Architecture represented by a group of six boxes 104, and each named as indicated in the corresponding row of the column 105 to the right of the boxes. Again, bit position numbers 0 and 15 appear above the boxes 104.

FIG. 3 also shows the 32-bit EFLAGS register of the Intel® Architecture as a box 106, and the 32-bit EIP register as a box 107. Both of these boxes have bit position numbers 0 and 31 appearing above them.

D language statements which describe this structure are shown in Listing 4. Listing 4 begins with definitions of the segment registers. The segment registers have a uniform structure—each is 16 bits—and have, for the most part, simple instructions associated with them which merely copy values into and out of them.

The first statement at the top of Listing 4 is in the syntactic category HardwareStatement, and begins with the keyword ‘hardware’. A HardwareStatement introduces an identifier for a pre-existing physical object which forms part of the software-visible hardware of a computer. A HardwareStatement has a structure similar to a NewStatement, but lacks syntax to support object initialization. The D language assumes that hardware is initialized by hardware. More specifically, since hardware objects exist before any software can run, the compiler cannot enforce the requirement that a hardware object be initialized after its creation and before its first use.

The HardwareStatement on line 8 of Listing 4 uses the parameterized class ‘Array_c’. This class is intrinsic to the D language. It represents the contiguous repetition in space of objects of the element class given as its first argument, the number of times indicated by its second argument. This statement therefore directly indicates six contiguous objects of class ‘_ia32RegSeg_c’. The identity of this array is at the end of the HardwareStatement, just before the terminating semicolon, and is ‘_ia32RegsSeg’. These are the segment registers represented by box 104 of FIG. 3.

Just before the identifier ‘_ia32RegsSeg’ is the keyword ‘local’. This indicates to the D language compiler that the object so described is available to it on the computer on which the compiler is executing. The alternative keyword ‘remote’ can be used in its place, which informs the D language compiler that it is being used as a cross-compiler. Cross compilation is explored in depth in later sections of this specification.

Thus, the HardwareStatement at the top of Listing 4 defines to the D language compiler that there is an object locally available on the computer, henceforth named ‘_ia32RegsSeg’, which is an array of six objects of class ‘_ia32RegSeg_c’.

The six statements following this HardwareStatement demonstrate another D language statement, the AliasStatement. An AliasStatement defines an identifier as the direct equivalent of an expression. The six aliases in Listing 4 allow a programmer to use in source code the Intel®-assigned names of the six segment registers, rather than the equivalent but unfamiliar subscript expressions shown.

On line 18 of Listing 4, the array of 32 bytes of the general-purpose registers is identified as‘_ia32RegsGen’. These are the registers represented by box 100 of FIG. 3. Since the Intel® Architecture does not address these registers as individual array elements, but rather by the names shown in FIG. 3, in various groupings, this definition is not sufficient for describing the architecture. In order to describe the general registers, there are eight union literals in Listing 4, each describing one of the eight general-purpose registers. Each of these union literals is followed by AliasStatements defining the names of the registers as defined by the Intel® Architecture.

As in other languages, the members of a union occupy the same storage locations. These unions contain structure literals, and again as in other languages, structure members are physically contiguous to each other. Some of the structure members are themselves union literals, in order to accomplish the overlapping arrangement of general-purpose registers seen in FIG. 3.

Examining the union literal beginning on line 20 of Listing 4, it can be seen that its first member is declared ‘inline struct’. The ‘inline’ keyword indicates that this union member has no separate identifier; rather, its members are aggregated directly into the union, and can be referred to without an intermediate qualifier. The ‘inline’ keyword is used for every member and nested member of this union literal. This is merely to avoid generating useless names for aggregates that are not defined in the Intel® Architecture.

It can be seen that the name ‘ax’ is given to an object of class ‘_ia32RegDByte_c’, and that this object occupies the same storage as the struct whose two members ‘al’ and ‘ah’ are adjacent to one another. These three members describe the low-order 16-bits of general-purpose register EAX. They are one of two members of a struct, the other member of which is an object of class ‘_ia32RegDByte_c’ identified as ‘anon’. ‘anon’ is a special identifier of the D language. It may be defined any number of times in a source program, and can never be referenced. Thus, ‘anon’ enables the definition of anonymous objects when syntax requires an identifier.

Finally, these two struct members are in a union with an object of ‘_ia32RegTByte_c’ named ‘eax’, representing the entire 32-bit general-purpose register. The entire outer union is declared by AtClause to be allocated to the first four bytes of the general-purpose register file _ia32RegsGen, and is named ‘Reg0’. AliasStatements following define the Intel® Architecture names for these registers.

In like manner, the remaining general-purpose registers are described in the remainder of Listing 4.

### Segment Register Class

Listing 5 shows the definition of class ‘_ia32RegSeg_c’. Here is an example of a D language class literal, which is in the same syntactic category as an interface literal, namely ClassifierLiteral. This class literal has an ‘implements’ clause, which contains in a pair of parentheses an entire interface literal. The interface represented by the literal is not identified in any NewStatement, and is therefore anonymous. The interface could have been defined separately, and referenced by its identifier in the ‘implements’ clause. However, as no other implementations of segment registers are contemplated, the interface is defined anonymously as shown.

Note that the interface literal specifies only two methods, both of which assign a value to a segment register. In designing this class, the decision was made to represent the instructions which transfer a segment register's state to and from the stack as methods of a stack class, and to represent the instructions which load a segment register in combination with a general register as global subroutines. There are a handful of other instructions scattered throughout the Intel® Architecture which modify specific segment registers, such as the CS (Code Segment) register, but these modifications are in connection with other object classes and so are not included here.

Thus, the interface specifies two overloads of the ‘assign’ predefined identifier. The D language compiler is able to distinguish between these overloads by their formal arguments. More precisely, each ModifiedClassifierMemberSpec specifies a member method using different FormalArguments to the parameterized class ‘Subr_c’. This is helpful in assembly level programming, as will be seen in later sections.

### Subroutine Arguments

The first overload of ‘assign’ takes a single argument of the class of the low-order 16 bits of a general-purpose register, ‘_ia32RegDByte_c’. Note the exclamation point ‘!’ in Listing 5 following the class name ‘_ia32RegDByte_c’. This indicates to the D language compiler that the actual argument must be a reference to a programmer-specified object, not a compiler-generated object.

An actual argument which is an expression designating an object which exists before the call to the subroutine taking the argument is termed an “actual object argument”. A formal argument requiring such an actual argument is termed a “formal object argument”. Either is termed an “object argument.”

A formal argument that does not require an actual object argument is termed a “formal value argument”. An actual argument which is not an object argument is termed an “actual value argument”. Either an actual value argument or an actual object argument may be passed to a subroutine where the corresponding formal argument is a formal value argument.

In other words, a value argument serves to pass to a subroutine the value of an object or an expression, embodied in some object accessible to the subroutine. An object argument serves to pass to a subroutine a reference to particular object designated by the source code of the subroutine invocation. Typically, an actual value argument is an expression designating an object created by the D language compiler to hold a copy of the value of another object or expression.

Of necessity, an argument which may be modified by a called subroutine (marked with the keyword ‘var’ or ‘returns’ in a FormalArguments literal) must be an object argument. Without this requirement, a programmer could code a subroutine intended to pass data back to its caller by modifying one of its arguments, and the actual argument could be a temporary object generated by the compiler, which is immediately discarded after the called subroutine returns.

By contrast, an argument which may not be modified by a called subroutine (marked with the keyword ‘con’ in the FormalArguments literal, or left unmarked) may be an object argument, or may be a value argument. The choice of which to use is left to the D language compiler, unless the class expression in the FormalArguments is postfixed with an exclamation point, in which case the D language compiler will require the invoking source code to specify an object and not a value.

Referring again to Listing 5, whatever expression is used as an actual argument to the first ‘assign’ method must resolve to a reference to the low-order 16-bits of a general-purpose register. As has already been seen, Listing 4 contains the definitions of the Intel®-assigned names of the low order 16-bit halves of the eight general registers. One of these names would suffice as an argument, and would be the most common argument found in a D language assembly level program.

### An Aside on Terminology

The D language is designed to be able to express all of the specifics of any computer architecture, and yet be independent of any of them. In order to achieve this goal and keep the terminology of the D language clear, the D language completely avoids the term “word” for contiguous groupings of bits. Historically, the term word has been defined as the number of bits acted upon as a unit by a computer of a particular architecture. Thus, the term is by definition specific to a given architecture, and not at all universal. For instance, an Intel® word is 16 bits while an IBM mainframe word is 32 bits. To accommodate larger groups of bits, Intel® has the doubleword (32 bits) and quadword (64 bits). On an IBM mainframe, a doubleword is 64 bits, and another term, halfword, connotes 16 bits.

Complicating this picture is the fact that, as computers have grown in size over the years, their word sizes have doubled and quadrupled, but their manufacturers have been reluctant to abandon the original size connoted by their use of the term word. Thus, it is more true in the original sense of the term that an Intel® Pentium® computer's word size is 32 bits (which is why it is referred to as a 32-bit computer), and yet the term word retains the connotation of 16 bits in an Intel® Pentium® program. (Pentium® is a registered trademark of Intel Corporation.)

The D language is designed to be able to express all of the specifics of any computer architecture, and yet be independent of any of them. In order to achieve this goal and keep the terminology of the D language clear, the D language uses a unique set of terms. First, the term byte is defined as “an 8-bit unit of storage”, where storage can be a memory cell, a register, or any other physical object in a computer capable of retaining state. Byte is distinguished from a group of eight bits represented transitorily as the state of a communication link. For the purposes of the D language, storage is more important than communication. However, this choice of terminology in no way limits the ability of programs in the D language to express the copying of a storage byte into states representing the equal octet on a communication link, or the copying of those states back into a storage byte.

For groups of contiguous bytes, the D language uses prefixes based on the Greek names for numbers. Table 4 below gives these terms, their abbreviations used conventionally in D language source code, and mappings to the equivalent Intel® and Sun terms.

TABLE 4
D Language Terms for Various Storage Sizes.

| name | size (bits) | abbreviation | Intel ® term | Sun term |
|---|---|---|---|---|
| byte | 8 | ‘Byte’ | byte | byte |
| dibyte | 16 | ‘DByte’ | word | halfword |
| tetrabyte | 32 | ‘TByte’ | doubleword | word |
| octobyte | 64 | ‘OByte’ | quadword | doubleword |
| hexadecabyte | 128 | ‘HdByte’ | | quadword |

### Pointers

Referring again to Listing 5, it can be seen that the second overload of ‘assign’ on lines 25-27 takes a single argument of the class of a pointer to a dibyte (16 bits) in memory, ‘_ia32pArg2Mem_c’. What is important to note here is that, in the D language, there can be many user-defined classes of pointers. A traditional pointer object in other languages is usually of a single class. Such a pointer is typically an object in main memory containing a single absolute memory address of another object in main memory. In the D language, a pointer is merely an object whose value signifies another object. The pointer may exist in main memory, a register, or elsewhere, and the object it signifies may be in main memory, a register, or elsewhere.

### Instruction Encoding

After the closing brace of the interface literal on line 28 of Listing 5, and the closing parenthesis of the implements clause on line 29, the opening brace of the class literal appears on line 28. Between this and the matching closing brace at the end of Listing 5 is the body of the class literal which is being used to initialize the object named ‘_ia32RegSeg_c’. The body contains the implementations of the two methods identified in the interface literal. Note that the bodies of the methods, enclosed in braces in the traditional manner for bracketing the body of a subroutine, are further enclosed in parentheses. This indicates usage of the object initialization syntax as in a NewStatement. The precise meaning of a member method subroutine definition such as this is “define a subroutine object, of class ‘Subr_c’ as parameterized by the formal arguments and ensure clause given, which is a member of the enclosing class, whose initial value is given by the initialization expression in parentheses following the object identifier.” Although in this and most cases of subroutine definition, the subroutine object is constant, this syntax allows the definition of a variable subroutine object, upon which operations such as assignment can be carried out. This facility will be explored further in later sections.

Referring to the first method implementation, it can be seen that its body consists of two InlineStatements. An InlineStatement is a direction to the D language compiler to evaluate the expression following the keyword ‘inline’, at compile time, and to replace the InlineStatement with an object of the class given by the expression, initialized by the value of the expression. The first InlineStatement is ‘inline _ia32MemByte_c(16#8e#);’, which invokes an initializer of class ‘_ia32MemByte_c’, passing it a literal expressing the hexadecimal value 8e. The class ‘_ia32MemByte_c’ is the class of a byte of memory in an Intel® Architecture computer. The net effect of this statement is that the compiler stores a single byte with the hexadecimal value 8e in the object code it generates from this statement. As this statement appears in the body of a method, the indicated object becomes part of the object code generated by the compiler for the body of the method.

The second InlineStatement also invokes a class initializer, but this is of the class ‘_ia32ModRmOnly_c’, which is a so-called inline argument pointer.

### Inline Argument Pointers

In most computers, most instructions are encoded starting with a byte or bytes containing values that map to so-called operation codes, or opcodes. A particular computer architecture defines a set of opcodes as mapping to operations on a computer implementing that architecture. In a computer, the state of the bits representing an opcode cause the hardware to cycle through certain states, to achieve the effect on the state of the computer specified by the corresponding operation.

Most instructions are defined such that bytes following their opcodes encode a reference or references to one, two, or sometimes more so-called operands. Operands are the physical, state-containing objects of the computer which participate in the operation designated by the opcode which begins the instruction which references them. The operands are read or modified, or both, by the operation.

In the object-oriented terminology of the D language, the bytes following an opcode which encode references to operands are called inline argument pointers. Such bytes are pointers because they are objects which signify other objects, namely the operands. In order to remain consistent with the rest of the terminology of the D language, these bytes are called argument pointers rather than operand pointers, thus indicating their similarity to the arguments of subroutines. Since these bytes contiguously follow opcode bytes in memory, they are called inline argument pointers.

Unlike traditional pointers, inline argument pointers often signify more than one object, and these objects are not always in main memory—they may be registers or other objects peculiar to a computer architecture. They also often encode a main memory address as the result of an arithmetic operation performed by hardware. For instance, in the Intel® Architecture, an inline argument pointer can signify the address of an object in memory as the result of multiplying a value in a designated general-purpose 32-bit register by four, adding to the product an offset value specified by some of the bytes of the inline argument pointer, and adding the sum to a value in another designated general-purpose 32-bit register.

As might be imagined from the foregoing, the encoding of inline argument pointers can be complex. The encoded result can also be a varying number of inline bytes. The challenge to a programmer designing D language classes representing a computer architecture is to design a set of classes that can directly encode the inline argument pointers defined by the architecture, such that they can be incorporated into encoded instructions using an InlineStatement.

### Intel® Architecture Inline Argument Pointers

Many of the Intel® Architecture instructions expect bytes of a particular format to immediately follow their opcodes, as inline argument pointers. These bytes are described in Intel Corporation, “Intel Architecture Software Developer's Manual, Volume 2: Instruction Set Reference”, Santa Clara, Calif., Intel Corp., 1999, which is incorporated herein by reference.

The first of these bytes is the so-called ModR/M byte. It may signify the presence of another byte, the SIB byte. The encoding of these bytes may additionally specify the presence of a signed 8-bit displacement, or a larger displacement. Whether the larger displacement is a 16- or 32-bit displacement depends on the address size attribute in effect, which in turn depends on modes set in Intel® Architecture control registers and address tables, and optional instruction prefixes.

The combination of ModR/M, SIB, and displacement bytes encodes pointers to two instruction arguments (called operands in Intel® documentation). The first argument is usually a general-purpose register. Whether it is a byte register, dibyte (word) register, or tetrabyte (doubleword) register depends on the opcode and the current operand size attribute. Like the address size attribute, the operand size attribute is controlled by modes set in Intel® Architecture control registers and address tables, and optional instruction prefixes. The first argument may also be a segment register, which is always 16 bits in size.

The second argument may be a general-purpose register, or it may be an argument in main memory. The argument's size again depends on the opcode and the current operand size attribute. Memory arguments may be addressed in a wide variety of ways. The ModR/M and SIB bytes combine to specify an expression which calculates the address of the first (lowest-numbered) byte in memory of the argument. The expression may calculate the address as any of the following: the value in a general-purpose register; the sum of the values in two general-purpose registers; the value of an immediately following displacement; the value of an immediately following displacement added to the value in a general-purpose register; the value of an immediately following displacement added to the sum of the values in two general-purpose registers; the value of an “index” general-purpose register, “scaled” by multiplying by 2, 4, or 8, and the product added to the value of a “base” general-purpose register; and the value of an “index” general-purpose register, “scaled” by multiplying by 2, 4, or 8, and the product added to sum of the values of a “base” general-purpose register and an immediately following displacement.

### Description in the D Language of Intel® Architecture Inline Argument Pointers

In brief, the complexities of Intel® Architecture inline argument pointers are described as follows. A family of classes implementing a certain interface represents the possible inline pointers to the first argument of an arbitrary instruction. A family of classes implementing a second interface represents the possible inline pointers to the second argument of an arbitrary instruction. There is a third family of classes such that for each valid combination of ModR/M, SIB, and displacement bytes, there is a class whose data members are exactly those bytes. An instance of one of these classes may be inlined after an opcode to generate the required ModR/M, SIB, and displacement bytes. The initializers of each of these classes take two arguments, the first being any class implementing the interface to inline pointers to argument one, and the second being any class implementing the interface to inline pointers to argument two.

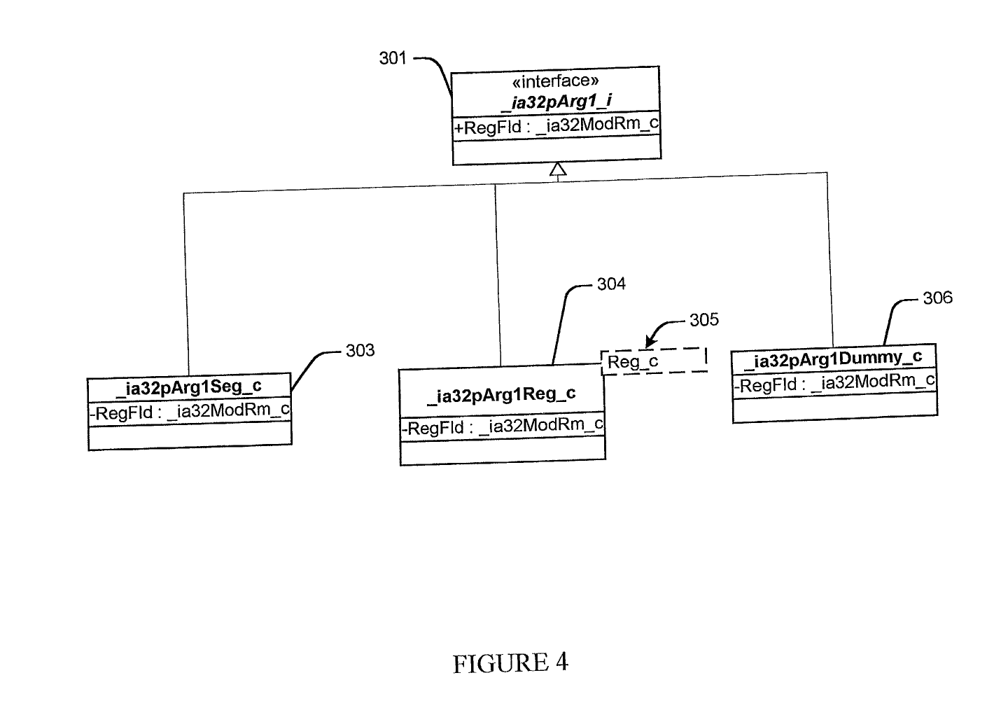

FIG. 4 is a UML diagram depicting the family of classes representing inline pointers to the first argument of an instruction. Box 301 represents interface ‘_ia32pArg1_i’. It has a single attribute, an instance of class ‘_ia32ModRm_c’ representing the reg field in an Intel® ModR/M byte. Here is an example of a D language interface with a data (non-subroutine) member. Unlike Java®, a D language interface can have data members as well as method and function members. A data member in an interface is a requirement that any class which implements that interface must have a data member of the same class or a subclass thereof. This fact is used to expose a class's attributes through an interface in much the same way its methods and functions are exposed. Since a variable class is a subclass of a constant class, this allows access to a class's attributes to be read-only outside class members, and read-write within class members.

Three classes implement ‘_ia32pArg1_i’. The class ‘_ia32pArg1Seg_c’ 303 represents a reference to a segment register. The class ‘_ia32pArg1Reg_c’ 304 represents a reference to a general-purpose register. Box 304 depicts this class as a parameterized class. The parameter ‘Reg_c’ 305 is the class of general-purpose register to which this pointer points, specifically ‘_ia32RegTByte_c’ for a 32-bit general-purpose register, ‘_ia32RegDByte_c’ for the low-order 16 bits of a general-purpose register, or ‘_ia32RegByte_c’ for an 8-bit portion of one of the first four general-purpose registers. The class ‘_ia32pArg1Dummy_c’ 306 represents a placeholder pointer to argument one when instruction use ModR/M bytes to reference argument two, but there is no argument one.

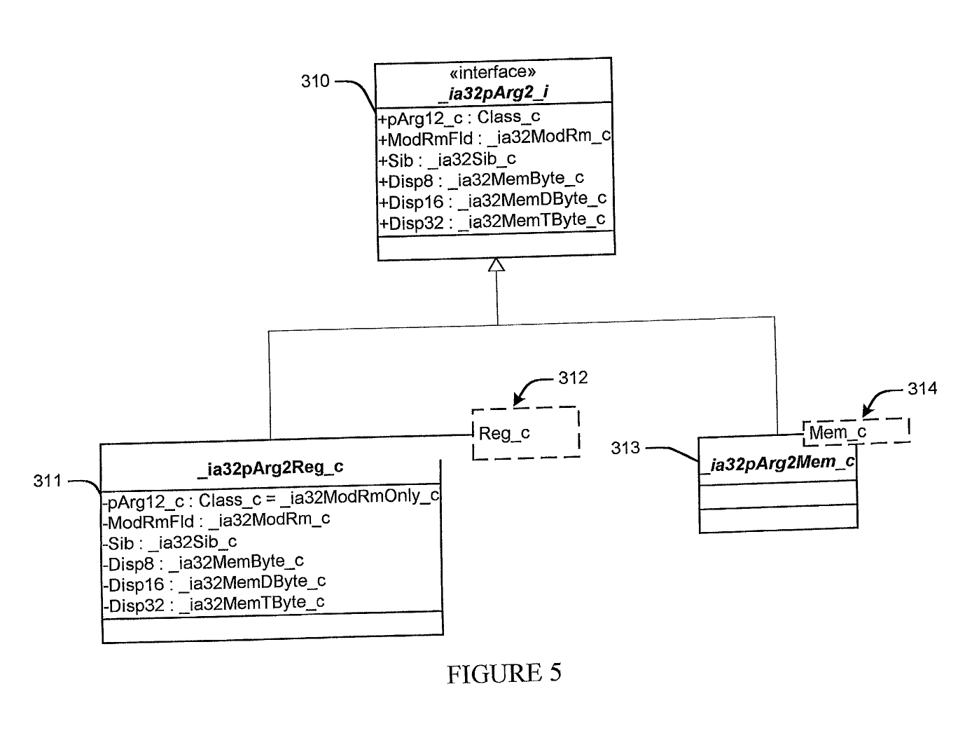

FIG. 5 is a UML diagram depicting the family of classes representing inline pointers to the second argument of an instruction. Box 310 represents interface ‘_ia32pArg2_i’. It can be seen that this interface has six attributes. On consideration of the design of Intel® Architecture inline argument pointers, it is realized that only the form of reference to the second of two instruction arguments determines what combination of ModR/M, Sib, and displacement bytes is needed. Thus, the classes implementing ‘_ia32pArg2_i’ determine which combination of bytes to use. Each class implementing ‘_ia32pArg2_i’ places a reference to the meta-class object of the class representing those bytes in data member ‘pArg12_c’. The remaining attributes of ‘_ia32pArg2_i’ are a shopping list of those bytes.

Two classes implement ‘_ia32pArg2_i’. The class ‘_ia32pArg2Reg_c’ 311 represents a reference to a general-purpose register. Box 311 depicts this class as a parameterized class. The parameter ‘Reg_c’ 312 is the class of general-purpose register to which this pointer points. This class is parallel to ‘_ia32pArg1Reg_c’, shown as box 304 in FIG. 4. The class ‘_ia32pArg2Mem_c’ 313 in FIG. 5 is a parameterized abstract base class for the family of classes representing the many addressing forms available when argument 2 is in main memory. Like the general-purpose register pointer classes, it takes a parameter; however, this parameter ‘Mem_c’ 314 is a class of memory object, specifically ‘_ia32MemTByte_c’ for four contiguous bytes in memory, ‘_ia32MemDByte_c’ for two contiguous bytes in memory, or ‘_ia32MemByte_c’ for one byte in memory.

There are about 33 parameterized classes derived from ‘_ia32pArg2Mem_c’, each of which represents one of the addressing forms implemented in the Intel® Architecture. Only a few of them will be presented in this specification, in later sections, in order to illustrate the method by which the D language expresses a variety of inline argument pointers.

### Pointers to Registers

Referring again to Listing 5, the second InlineStatement in the body of the first method of class ‘_ia32RegSeg_c’, on line 37, invokes an initializer of the class ‘_ia32ModRmOnly_c’, as already mentioned above. The name of this class reflects its purpose, which is to describe an inline argument pointer of the Intel® Architecture for 32-bit computers, where that pointer consists solely of a single byte called by Intel® the ModR/M byte. The ModR/M byte contains three bit fields capable by themselves of encoding a number of types of argument pointers. In this class method, the form of ModR/M byte of interest is the one which encodes a reference to a general-purpose 32-bit register as instruction argument 2, the source argument, and a reference to a segment register as instruction argument 1, the destination argument.

By examining the second lineStatement, it can be seen that class ‘_ia32ModRmOnly_c’ must have an initializer which takes two arguments. The first actual argument passed to the initializer is itself the result of invoking another initializer, that of class ‘_ia32pArg1Seg_c’, which is represented in FIG. 4 as box 303.

Again, class ‘_ia32pArg1Seg_c’, as its name implies, represents an inline argument pointer to argument one of an arbitrary Intel® instruction, where that argument is a segment register. In this example on lines 37-40 of Listing 5, the argument passed to an initializer of ‘_ia32pArg1Seg_c’ is ‘this’, the predefined identifier representing the current object. Since this method is a member of class ‘_ia32RegSeg_c’, the class of segment registers, the current object must be a segment register. The initializer of class ‘_ia32pArg1Seg_c’ so invoked initializes an object referencing the current segment register.

Listing 6 shows the D language source code for class ‘_ia32pArg1Seg_c’. Note that this class implements two interfaces: the interface ‘_ia32pArg1_i’ introduced as box 301 of FIG. 4, and an anonymous interface specified inline. The interface ‘_ia32pArg1_i’ imposes the requirement that this class have a data member ‘RegFld’, which it does. The anonymous interface to class ‘_ia32pArg1Seg_c’ supplies the public initialization method invoked in Listing 5. It accepts a single object argument, a reference to a segment register.

As can be seen on line 24 of Listing 6, the initializer method of class ‘_ia32pArg1Seg_c’ simply initializes ‘RegFld’ by calling an initializer of its class, ‘_ia32ModRm_c’. That initializer's code is so brief as to be reproduced below, without enclosing quotation marks:

## Initialize a ModR/M referencing a segment register as Arg1.
method virinit Subr_c<? con_ia32RegSeg_c! Reg1 ?> InitReg1
({

ModRm(_ia32RegIndex (Reg1) << 3);
});

‘_ia32RegIndex’ is a global subroutine which, when passed a segment register reference as argument, returns a number. Its code is shown below, without enclosing quotation marks:

new Subr_c<? con_ia32RegSeg_c! Reg, returns_ia32MemByte_c xR ?>
_ia32RegIndex

({

select
{

($Reg == $es) {xR(16#00#);} break;
($Reg == $cs) {xR(16#01#);} break;
($Reg == $ss) {xR(16#02#);} break;
($Reg == $ds) {xR(16#03#);} break;
($Reg == $fs) {xR(16#04#);} break;
($Reg == $gs) {xR(16#05#);} break;

}

});

The operator symbol ‘$’ represents the so-called indexOf operator. This operator is built into the D language compiler. For any object allocated to one or several contiguous elements of an array, the indexOf operator returns an index object initialized to the zero-based index to the lowest-numbered array element allocated to that object.

The SelectStatement shown above is a means of specifying alternative control flow. A SelectStatement contains a list of so-called guarded StatementBlocks in its body. Each StatementBlock is preceded by a Boolean expression in parentheses, called a Guard. When the SelectStatement is executed, all of the Guards are evaluated. The StatementBlock whose corresponding Guard is true is executed. If more than one StatementBlock has a true Guard, then one of those StatementBlocks is arbitrarily chosen to be executed. Upon completion of the execution of the chosen StatementBlock, the SelectStatement is exited if the keyword ‘break’ follows the StatementBlock. If the keyword ‘continue’ follows the StatementBlock, then execution of the SelectStatement is repeated. If none of the Guards is true, an error occurs.

### Index Objects

An index object is an object which encapsulates both a reference to an array object and a subscript to an element of that array. The semantics of an index are very similar to that of a C-language pointer, or a Standard C++ Library array iterator, with a few distinctions. Arithmetic is possible on an index: an integer may be added to or subtracted from an index, provided the resulting index value has a subscript within the range valid for the array. One special subscript value is allowed which does not designate an array element, and that is the value which indexes just past the last element of the array. Two indexes designating an element in the same array may be subtracted from one another, yielding an integer result.

A C language pointer can be thought of in terms of a D language index which indexes main memory. However, a C language pointer carries with it the class of a referent, whether that referent is an array element or merely an ordinary resident of main memory. C language pointers support the same kind of arithmetic as D language indexes, but if arithmetic is done on a C language pointer that does not point to an element of an array, the result is invalid.

By contrast, a D language index carries with it both the identity of the referent array, and the class of an element of that array. This allows a D language index to reference array objects such as general register arrays, and guarantees that index arithmetic is safe. It also allows a D language index to be used to refer to user-defined arrays that are allocated to memory or register arrays. D language pointers are distinct from indexes, and do not support index arithmetic.

Referring back to Listing 4, it can be seen that each segment register name is an alias to an element of an array object named ‘_ia32RegsSeg’, representing the segment registers. Thus, in the body of ‘_ia32RegIndex’ shown above, each of the six expressions testing for equality is comparing whether the segment register represented by formal object argument ‘xR’ has the same index as the register named. If so, the subroutine's return value is set to the value corresponding to the reg field value of the Intel® Architecture ModR/M byte which signifies that register. The ‘InitReg1’ method shown earlier shifts this value left by three bit positions, to align the value in the reg field of the ModR/IM byte.

By definition, as mentioned earlier, the intrinsic parameterized class ‘Subr_c’ defines an object containing instructions that can be copied inline to the point in the code where the subroutine object is invoked, with the appropriate replacement of formal arguments with actual arguments. To this point, there have been no definitions made which make it possible for a subroutine object to be invoked with the usual call/return mechanism. That mechanism is presented much later in this specification. Considering D as an assembly-level language, it is most appropriate to interpret the D language subroutines seen so far as all being inserted into the code invoking them, with argument substitution.

The argument to ‘_ia32RegIndex’ shown above must be an object argument so that the indexOf operator used in ‘_ia32RegIndex’ obtains the index to the actual segment register argument passed to it. Without the guarantee of an object argument, the indexOf operator could produce an index to an object holding a copy of the state of the segment register passed.

Referring back to Listing 5, to the first method implementation in class ‘_ia32RegSeg_c’, the second argument to ‘_ia32ModRmOnly_c’, on line 39, is the result of invoking an initializer of parameterized class ‘_ia32pArg2Reg_c’. This is the class represented by box 311 in FIG. 5. It represents an inline argument pointer to argument two of an arbitrary Intel® instruction, where that argument is a general-purpose register. The argument to ‘_ia32pArg2Reg_c’ is another class, the class designating whether the entire 32-bit general-purpose register is to be referenced (‘_ia32RegTByte_c’), or only the low-order 16 bits (‘_ia32RegDByte_c’) or an 8-bit portion (‘_ia32RegByte_c’). Listing 5 shows this argument to be ‘_ia32RegDByte_c’, as the instruction being encoded copies 16 bits from a general-purpose register to a 16-bit segment register.

This second argument to ‘_ia32ModRmOnly_c’ is thus an invocation of an initializer of class ‘_ia32pArg2Reg_c(_ia32RegDByte_c)’, passing a single argument to the initializer which is the argument of the assign method, namely ‘Rhs’. Since the formal argument ‘Rhs’ is defined to be a reference to an object of class ‘_ia32RegDByte_c’, the actual argument must therefore designate the low-order 16 bits of a general-purpose register. The initializer of class ‘_ia32pArg2Reg_c(_ia32RegDByte_c)’ encodes a reference to this register as an inline argument pointer to argument two of an Intel® instruction, using a pattern similar to that just described for argument one.

Listing 8 shows the D language source code for class ‘_ia32pArg2Reg_c’. Like ‘_ia32pArg1Reg_c’, it implements a named interface and an anonymous interface. The anonymous interface defines the ‘initialize’ method invoked by the second argument to ‘_ia32ModRmOnly’, shown on line 39 of Listing 5.

Line 21 of Listing 8 shows the initialization of class member ‘pArg12_c’ with a reference to another class, ‘_ia32ModRmOnly_c’. ‘pArg12_c’ is the member whose value is a reference to the class describing exactly those bytes forming the inline argument pointer. The expression on line 21 ‘_ia32pMem_c(Class_c)@’ defines a reference object. The class ‘_ia32pMem_c’ is a pointer class, a class whose objects signify an object in main memory. It is a parameterized class, taking a single parameter indicating the class of objects signified by pointer objects of this class. On line 19, the parameter is ‘Class_c’. Thus, ‘_ia32pMem_c(Class_c)’ is a pointer class whose objects signify instances of meta-classes in main memory. The ‘@’ appended to the end of the expression indicates that the object defined in this member definition statement is to be implicitly dereferenced wherever its identifier is used, except in an initialization expression. The effect of the postfixed ‘@’ is that the identifier declared on line 19 is equivalent to a reference to the object to which the identified pointer points. A pointer object defined in this manner is termed a reference object.

Line 23 of Listing 8 defines member ‘ModRmFld’ without initialization, even though its class is qualified with the keyword ‘con’. The ‘con’ qualifier prevents an object from being modified after initialization, but it does not require immediate initialization. In the case of this class, the initial value of ‘ModRmFld’ is calculated by the initialize method, as will be seen below.

The remaining four data members of this class are the remaining members required by interface ‘_ia32pArg2_i’, but are unneeded by this class. These are declared on lines 26-29 of Listing 8, with default initialization.

Line 32 of Listing 8 shows the body of the ‘initialize’ method declared in the anonymous interface this class implements. It is merely a call to an initializer of class ‘_ia32ModRm_c’ to initialize ‘ModRmFld’. That initializer's code is so brief as to be reproduced below, without enclosing quotation marks:

method virinit Subr_c<? con_ia32RegDByte_c! Reg2 ?> InitReg2
({

ModRm(16#c0# | _ia32RegIndex (Reg2));

});

The hexadecimal value C0 is copied into the ‘ModRm’ member so that the Mod bit field of the Intel® ModR/M byte contains two one bits, indicating to hardware that the second instruction argument is a general-purpose register.

_ia32RegIndex’ is an overloaded identifier for a global subroutine. This identifier is shown earlier in this specification as identifying a global subroutine accepting a segment register as an actual object argument, and returning a segment register number. When passed a dibyte register as an actual object argument, the version of the global subroutine selected by the D compiler is that shown below, without enclosing quotation marks:

new Subr_c<? con_ia32RegDByte_c! Reg, returns_ia32MemByte_c xR ?>
_ia32RegIndex
({

select
{

($Reg == $ax) {xR(16#00#);} break;
($Reg == $cx) {xR(16#01#);} break;
($Reg == $dx) {xR(16#02#);} break;
($Reg == $bx) {xR(16#03#);} break;
($Reg == $sp) {xR(16#04#);} break;
($Reg == $bp) {xR(16#05#);} break;
($Reg == $si) {xR(16#06#);} break;
($Reg == $di) {xR(16#07#);} break;

}

});

By this means, supported in part by the parameterized class facility and the overloading facility of the D language, the ‘initialize’ method of ‘_ia32pArg2Reg_c’ initializes its data member ‘ModRmFld’ to contain values in the Mod bit field and R/M bit fields of the Intel® Architecture ModR/M byte indicating that instruction argument 2 is the general-purpose register identified by the actual argument corresponding to its formal argument ‘Reg2’.

This concludes the description of the two arguments to ‘_ia32ModRmOnly_c’ on line 39 of Listing 5. These two arguments are then synthesized by an initializer of class ‘_ia32ModRmOnly_c’ into a ModR/M byte of the format specified by the Intel® Architecture, through a bit-wise or operation. The source code for that initializer is shown below without enclosing quotation marks.

method virinit Subr_c<? _ia32ModRm_c Arg1, _ia32ModRm_c Arg2 ?>

initialize

({

## There must not be any overlap between the two.
assert ((Arg1.ModRm & Arg2.ModRm) ==0);
ModRm (Arg1.ModRm | Arg2.ModRm);

});

Referring now once again to line 39 of Listing 5, it can be seen that the above initializer is invoked in an InlineStatement. As a result, the one data member of class ‘_ia32ModRmOnly_c’, a single byte, is placed in the generated object code for this method, in the position of the InlineStatement. It is important to note that the Inline Statement specifies the invocation of the initializer by the compiler during compilation. Any intermediate objects created by the initializer so invoked, or by other routines it may invoke, are destroyed by the compiler after the method in which they are invoked is compiled. All that is kept, by virtue of the InlineStatement, is the object initialized by the initializer invoked in the InlineStatement. By this means, complex arguments are reduced to a single byte of the form demanded by the architecture, or as will be seen below, a sequence of bytes of the appropriate form.

What is also significant is that a D language program can cause the D language compiler to invoke code in the input of the compiler as part of the compilation process. This enables the novel compilation technique described below.

### Pointers to Memory

To this point, the designs of classes have been shown which describe a segment register as instruction argument one, and a general-purpose register as instruction argument two. To complete the presentation of information necessary to demonstrate how the D language describes and encapsulates a computer architecture, the design of classes will be shown which describe an object in memory as instruction argument two.

The class ‘_ia32pArg2Mem_c’ is the parameterized abstract base class of all inline argument pointers to instruction argument 2 when that argument is in memory. This parameterized class is shown as box 313 of FIG. 5. It can be seen from FIG. 5 that class ‘_ia32pArg2Mem_c’ implements interface ‘_ia32pArg2_i’ 310, the interface implemented by all classes describing instruction argument two in the Intel® Architecture. The parameter to ‘_ia32pArg2Mem_c’ is represented in FIG. 5 by ‘Mem_c’ 314, and indicates the class of memory object to which this second argument pointer points. This parameter can be ‘_ia32MemByte_c’, ‘_ia32MemDByte_c’, or ‘_ia32MemTByte_c’, for an 8-bit, 16-bit, or 32-bit memory object, respectively.

About 30 classes derive from ‘_ia32pArg2Mem_c’, each one representing one of the possible addressing forms implemented in the hardware of a computer conforming to the Intel® Architecture. As an example of these derived classes, Listing 9 shows the D language source code for class ‘pBDisp8’. This class represents the addressing form for an inline argument pointer to instruction argument 2 in main memory, where the address of the argument is calculated by adding a signed 8-bit displacement to a value held in a general register. It is very similar in form to the source code for class ‘_ia32pArg2Reg_c’ shown in Listing 8.

The initializer of ‘pBDisp8’ accepts two arguments, an object which is a 32-bit general-purpose register, identified by formal argument ‘Base’, and a value which can be copied to a byte in main memory, identified by formal argument ‘Disp8’.

Note that the member ‘pArg12_c’, referencing the class of the sequence of inline argument pointer bytes, is not initialized at the point of its definition on line 26. That initialization is done in the body of the ‘initialize’ method, based on arguments to the method.

For most base registers, the Intel® Architecture specifies the addressing form of a signed 8-bit displacement added to a value in a base register using a ModR/M byte and a displacement byte. In this form, the ModR/M byte, represented in this class as ‘ModRmFld’ on line 28 of Listing 9, contains a Mod bit field of 01₂, and an R/M bit field indicating the general-purpose register containing the base address value, as an index in the range 000₂ through 111₂. However, if the general-purpose register is ESP, an additional byte, the SIB byte, is necessary.

The body of the ‘initialize’ method, shown on lines 37-50 of Listing 9, implements these addressing forms. Firstly, the argument ‘Disp8_’ is copied to the class member ‘Disp8’. Then, the index of the argument ‘Base’ is compared to the index of the general-purpose register ‘esp’. If they are equal, member ‘pArg12_c’ is initialized to refer to the class of inline argument pointer ‘_ia32ModRmSibDisp8_c’, and the initializer method ‘SibDisp8Follow’ is called to initialize ‘ModRmFld’ to hexadecimal 44, the special value of the Mod and R/M fields of a ModR/M byte that indicate to an Intel® Architecture computer that a SIB byte and displacement byte follow the ModR/M byte. Note that class member ‘Sib’ on line 29 is pre-initialized to a SIB byte indicating ESP as a base register. Objects of class ‘_ia32Sib_c’ are initialized to the various bit fields defined by the Intel® Architecture in the same manner as class _ia32ModRm_c.

If the index of ‘Base’ is not equal to the index of ‘esp’, member ‘pArg12_c’ is initialized to refer to the class of inline argument pointer ‘_ia32ModRmDisp8_c’, and the initializer method of ‘_ia32ModRm_c’ is called that takes two arguments, a Mod field and a base register object. The Intel® Architecture defines a Mod field of 01₂ as indicating the addressing form of an 8-bit displacement added to the value in the 32-bit register indexed by the R/M field of the ModR/M byte.

Thus, initializing an instance of the class ‘pBDisp8’, shown in Listing 9, with a general-purpose register as a base register, and a value as an 8-bit displacement, creates an object which specifies the class and value of an inline argument pointer to be used to accomplish the desired addressing form for instruction argument 2, when that argument is in memory.

Referring back to Listing 5, containing the source code for class ‘_ia32RegSeg_c’, it can be seen that the second ‘assign’ method, whose body is given on lines 47-52, takes an object argument of class ‘_ia32MemDByte_c’. This formal argument specification causes this overloaded ‘assign’ method to be selected by the D compiler whenever ‘assign’ is invoked on a segment register (an object of class ‘_ia32RegSeg_c’) with an argument which is an instance of ‘_ia32MemDByte_c’.

The NewStatement of line 48 of Listing 5 creates an object named ‘pRhs’ as a new instance of class ‘_ia32pArg2Mem_c(_ia32MemDByte_c)’, a pointer to instruction argument two when that argument is a dibyte (16 bits) in memory. It initializes this with a pointer to the method argument ‘Rhs’, using the operator ‘&’. The operator ‘&’ is interpreted in light of the actual object argument passed, as will be seen in a later section.

For the purposes of this example, it is assumed that the actual argument is addressed using an address form consisting of a general-purpose register and a signed 8-bit displacement. Such an argument causes ‘pRhs’ to be initialized to an object of class ‘pBDisp8’. If the base register is not ESP, the ‘pArg12_c’ member of ‘_ia32pArg2Mem_c(_ia32MemDByte_c)’ is initialized to reference ‘_ia32ModRmDisp8_c’, as has already been seen in Listing 9.

The code for class ‘_ia32ModRmDisp8_c’ is shown in Listing 10. It can be seen from this listing that the class has exactly two data members, one representing a ModR/M byte, and the second representing a byte containing an 8-bit displacement. The ‘initialize’ method of this class expects two arguments: the first being an object of a class implementing a inline argument pointer to instruction argument one, and the second being an inline argument pointer to instruction argument two. The method does nothing more than firstly to initialize its ModR/M field with the combination of the Reg field specified by the argument one pointer, and the Mod and R/M fields specified by the argument two pointer, and secondly to initialize its displacement byte with the ‘Disp8’ field of the argument two pointer.

If the actual argument to the ‘assign’ method of ‘_ia32RegSeg_c’ were an object addressed using ESP as a base register, the class referenced by ‘pArg12_c’ would be ‘_ia32ModRmSibDisp8_c’. The code for that class is as trivial as the code for ‘_ia32ModRmDisp8_c’, except that it has an additional data member, a Sib byte, which it initializes by copying the corresponding field from its argument two pointer.

The InlineStatement on line 51 of Listing 5 thus incorporates two or three bytes of the appropriate format into the object code for this ‘assign’ method, depending on the classes and values of the arguments to it.

In a manner similar to that described above, all of the main memory addressing modes of the Intel® Architecture are implemented in classes deriving from parameterized abstract base class ‘_ia32pArg2Mem_c’. By supplying to this class an argument indicating the class of memory object addressed, the entire set of addressing forms for the second argument to most Intel® Architecture instructions is implemented. Through a combination of overloading and the logic in the methods of these classes, statements can be coded in the D language causing the D language compiler to generate exactly the sequences of bytes required by the Intel® Architecture.

### Immediate Arguments

Some instructions in the Intel® Architecture expect operands to immediately follow opcode bytes in memory; these are termed immediate operands. Immediate operands are described in the D language using InlineStatements to copy the values of arguments into object code immediately following opcode bytes.

There is a version of the Intel® MOV instruction that takes an immediate operand and copies its value to a general-purpose register. Listing 12 shows part of the implementation of class ‘_ia32RegTByte_c’, the class of general-purpose registers. Lines 42-48 of Listing 12 show the implementation of the MOV instruction with an immediate operand. The general-purpose register that is the target of the MOV instruction is encoded into the low-order three bits of the opcode byte by the InlineStatement on line 46. Since an immediate operand is copied into memory following the opcode bytes of the instruction which references it, there is no need to pass an actual object argument to the subroutine implementing the instruction. That is why the argument ‘Rhs’ to this method is a value argument, not an object argument. A copy of the argument is placed inline following opcode bytes by the InlineStatement on line 47.

### Assembly Level Coding

By supplying the D language compiler with a complete description in the D language of the Intel® Architecture in the fashion just described, the D language may be used as an assembly language for the Intel® Architecture. Examples follow.

### General-Register Argument

The Intel® assembly language source code to move a 16-bit value from the low-order 16-bits of general-purpose register EAX to segment register ES is:

MOV ES, AX

The corresponding D language source code shown without enclosing quotation marks is: es.assign(ax);

This statement uses the traditional object-oriented programming syntax for invoking a method on an object. In this case, the object is the segment register ES, and the method is ‘assign’. ES is ofclass ‘_ia32RegSeg_c’. The implementation ofthe ‘assign’ method for this class is found beginning on line 32 of Listing 5. It can be seen that the first InlineStatement in this method causes the D language compiler to insert into the object code generated from this source code a byte with the hexadecimal value 8E. This is the opcode for the Intel® Architecture instruction which copies a value to a segment register. This instruction is defined as having inline argument bytes following the opcode, the first of which bytes is a ModR/M byte. The first instruction argument is the destination segment register, and the second instruction argument is the source object.

In this example, the first instruction argument is ES, which in D language terms is the current object referenced by the predefined identifier ‘this’. The second instruction argument is AX, the low-order 16 bits of the EAX register, which in the D source code is supplied as the argument to the ‘assign’ method as identifier ‘ax’. It can be seen that lines 37-40 of Listing 5 contain an InlineStatement which invokes an initializer of class ‘_ia32ModRmOnly_c’ described earlier in this specification. The first argument to the initializer is a pointer to instruction argument one when that is a segment register, where the actual argument is ‘this’, the current object. In this example, the current object is ES, so the first argument is a reference to the ES register, encoded for use as a first argument to an instruction. The second argument to the initializer is a pointer to instruction argument two when that is the low-order 16 bits of a general-purpose register, where the actual argument is the argument to the ‘assign’ method, Rhs. In this example, the argument is AX, so the second argument to the initializer of class ‘_ia32ModRmOnly_c’ is a reference to the low-order 16 bits of general-purpose register EAX, encoded for use as a second argument to an instruction. By the means described earlier in this specification, these two arguments are synthesized by the initializer of class ‘_ia32ModRmOnly_c’ into a single ModR/M byte, whose hexadecimal value in this case is C0. By virtue of the InlineStatement, the resultant byte is placed in the output of the compiler.

Because of the fixed mapping from operator symbols to method and function names, the above D language source code could also be written as shown below without enclosing quotation marks:

es:=ax;

The Intel assembly language statement shown above, and both D language statements shown above, generate the same sequence of two bytes, which are defined by the Intel® Architecture to accomplish the desired effect, namely the copying of a 16-bit value from the low-order 16 bits of the EAX register to segment register ES.

### Memory Argument

The Intel® assembly language source code to move a 16-bit value from memory to segment register ES, using EBP as base register and a displacement of −32, is:

MOV ES, WORD PTR [EBP−32]

The syntax of memory references in the Intel® assembly language such as that shown above is as follows. The keywords WORD PTR indicate that an expression is about to appear in square brackets which should be interpreted as providing the address of a word (dibyte) in main memory. The expression in square brackets must be one that can be directly evaluated by the instruction with which it appears, as defined in the Intel® Architecture. An assembler for the Intel® assembly language must employ several levels of pattern matching, recognizing in this case that the mnemonic MOV coupled with the first argument ES indicate that instruction which copies a value to a segment register. Further, the assembler recognizes that the keywords WORD PTR indicate that the second instruction argument is in memory, and the address expression [EBP−32] can be directly evaluated by the hardware when encoded in a ModR/M byte and an 8-bit displacement byte.

The corresponding D language source code shown below without enclosing quotation marks is:

es.assign(@pBDisp8(_ia32MemDByte_c)(ebp, −32));

‘pBDisp8’ is the name of the parameterized class derived from ‘_ia32pArg2Mem_c’ which encodes a pointer to an argument in memory whose address is calculated directly by the hardware by adding an 8-bit displacement to a value in a base register. In this example, the base register is EBP, and the displacement value is −32. The ‘@’ sign immediately preceding ‘pBDisp8’ is the D language built-in dereference operator. The expression beginning with the ‘@’ sign is interpreted as the object signified by the pointer object, rather than the pointer object itself.

This statement uses the traditional object-oriented programming syntax for invoking a method on an object, as did the earlier statement copying a value from a general-purpose register. The method argument in this case, however, is a de-referenced pointer to a dibyte in memory. The D language compiler recognizes that a dereferenced pointer is an object argument and so matches the above statement to the ‘assign’ method shown beginning on line 44 of Listing 5.

The body of this method contains a NewStatement on line 48 that initializes a pointer to a second instruction argument, ‘pRhs’, to point to the method's actual argument. Since, in general, if ‘pX’ is a pointer, and ‘@pX’ is a dereferenced pointer, then the expression ‘&@pX’ is equivalent to ‘pX’. Thus, the effect of the NewStatement on line 48 is to copy the pointer the actual argument supplied to this method, which in this case is ‘pBDisp8 (_ia32MemDByte_c) (ebp, −32)’.

The InlineStatement on line 51 of Listing 5 encodes ModR/M and displacement bytes to represent the inline pointers to arguments one and two required by the specification of the instruction with the opcode whose hexadecimal value is 8E. In this case, the ‘pArg12_c’ attribute of this instance of class ‘pBDisp8’ is ‘_ia32ModRmDisp8_c’. Objects of this class have exactly two data members: a ModR/M byte and an 8-bit displacement byte. Thus, the InlineStatement on line 51 causes the compiler to generate the bytes necessary to cause the hardware to calculate the address of the actual argument to this method.

In order to allow more intuitively acceptable assembly-level source code, and to cause source code to appear more similar to Intel® assembly language, an alias is defined in the D language as shown below without enclosing quotation marks:

alias _ia32MemByte_c Word;

Then, the prior D language statement is written as shown below without enclosing quotation marks:

es.assign(@pBDisp8(Word) (ebp, −32));

Because of the fixed mapping from operator symbols to method and function names, the above D language source code could also be written as shown below without enclosing quotation marks:

es:=@pBDisp8(Word) (ebp, −32);

The Intel assembly language statement shown above, and all three D language statements shown above (other than the AliasStatement), generate the same sequence of three bytes, which are defined by the Intel® Architecture to accomplish the desired effect, namely the copying of a 16-bit value from memory to segment register ES, the memory address being formed by subtracting 32 from the value in the general-purpose register EBP. That sequence, in hexadecimal, is 8E 45 E0.

### Global Objects

It is common in a computer architecture for there to be defined a register consisting solely of status bits that are set or reset as the result or side effect of operations on operands other than the register containing the status bits. In the Intel® Architecture, the EFLAGS register is such a register.

Although there is a class describing the EFLAGS register, which includes methods that operate directly on the EFLAGS register, there must be a way to indicate when instructions that are not members of the EFLAGS class affect its state as a side effect. This is accomplished through the use of named arguments.

A named argument is a formal argument using the keyword ‘named’ in its definition. When an expression invokes a subroutine with a named argument, no positional argument in the expression corresponds to the named argument. Instead, the lexical scope of the expression invoking the subroutine with a named argument must contain an object of the name given in the formal argument defining the named argument. The effect is much the same as that accomplished with the extem keyword in C and C++, except that in the D language external references made by subroutines are part of the formal interfaces to subroutines.

Consider the member method of class ‘_ia32RegTByte_c’ named ‘xor’, shown on lines 66-76 of Listing 12. An object named ‘_ia32Flags’, of class ‘_ia32Flags_i’, must be in the lexical scope of the caller. The fact that the argument is qualified with the ‘var’ keyword indicates that this method may modify the object. This D language code describes the operation of the Intel® Architecture instruction XOR, which sets bits in the EFLAGS register based on the result of the operation.

### Dataflow Attributes

Note the keyword ‘raninit’ in the code for ‘xor’ on line 67. This is one of a family of keywords described by the syntactic category DataflowAttribute. A DataflowAttribute describes changes in the allocation and initialization states of an argument object, and the meaning of the object's state (value), from the point of view of the caller of the routine. A dataflow attribute represents part of the contract offered by a routine to a calling routine.

The keyword ‘raninit’ is a compound DataflowAttribute and therefore has two halves. The first half, ‘ran’, describes the state of the corresponding actual argument at the point at which control is transferred to the called routine. ‘ran’ stands for random, and indicates that the corresponding actual argument has a value that has no meaning to the called routine. However, ‘ran’ does require that the actual argument be an initialized object of its class, that is, that the state of the actual argument object be valid for its class. By contrast, the DataflowAttribute ‘vir’ indicates an uninitialized (or finalized) object.

The second half of this DataflowAttribute keyword is ‘init’. This indicates to the caller that, upon return from the called routine, the corresponding actual argument has a value with some meaning to the caller. In this particular case, the ‘raninit’ DataflowAttribute informs the calling routine that the object named ‘_ia32Flags’ is modified in a known way by the ‘xor’ method. This reflects the fact that, in an Intel® Architecture computer, the EFLAGS register is modified in a known way by the Intel XOR instruction.

DataflowAttributes tell about the flow of data between calling routine and called routine. In this case, with regard to the named argument‘_ia32Flags’, data flows in only one direction, from the called routine back to the caller. DataflowAttributes also tell about changes in initialization states of objects access to which is shared by calling routine and called routine. In this case, with regard to the named argument ‘_ia32Flags’, the object remains initialized and its state is changed from one unknown to the ‘xor’ subroutine to one defined by the ‘xor’ subroutine.

A DataflowAttribute keyword is a simple DataflowAttribute keyword or a compound DataflowAttribute keyword. A compound DataflowAttribute keyword is formed with two simple DataflowAttribute keywords. The first of the two keywords indicates the state of the actual argument on call to the routine receiving the argument. The second of the two keywords indicates the state of the actual argument on return from the subroutine called.

The simple dataflow attribute keywords, and their meanings, are shown in Table 5 below.

TABLE 5
Simple DataflowAttribute Keywords

| keyword | meaning |
|---|---|
| ‘new’ | argument object does not exist before call and exists after |
| | return |
| ‘vir’ | argument object is not initialized |
| ‘ran’ | argument object is initialized, but its state is meaningless |
| ‘init’ | argument object is initialized and its state is significant |
| ‘del’ | argument object exists before call and does not exist after |
| | return |
| ‘alloc’ | before call, argument object is initialized, but its state is |
| | meangingless; after return, argument object is allocated as |
| | storage to some other object |
| ‘free’ | before call, argument object is allocated as storage to some |
| | other object; after return, argument object is no longer |
| | allocated, but its state is meaningless |

These keywords may be combined into compound keywords under the following rules. Firstly, ‘alloc’ and ‘free’ always stand alone, and never combine with other keywords. Secondly, ‘new’ may never be the second keyword in a compound keyword, and ‘del’ may never be the first keyword in a compound keyword. Finally, ‘new’ and ‘del’ may never be combined with themselves or each other. These rules produce the compound DataflowAttribute keywords shown in Table 6 below.

TABLE 6
Compound DataflowAttribute Keywords

| | | | |
|---|---|---|---|
| ‘newvir’ | ‘virvir’ | ‘ranvir’ | ‘initvir’ |
| ‘newran’ | ‘virran’ | ‘ranran’ | ‘initran’ |
| ‘newinit’ | ‘virinit’ | ‘raninit’ | ‘initinit’ |
| | ‘virdel’ | ‘randel’ | ‘initdel’ |

If one of the simple DataflowAttribute keywords (other than alloc or free) appears alone, then it is interpreted as a compound keyword, as follows:

‘new’: equivalent to ‘newran’

‘vir’: equivalent to ‘virvir’

‘ran’: equivalent to ‘ranran’

‘nit’: equivalent to ‘initinit’

‘del’: equivalent to ‘randel’

Finally, if a formal argument is specified with no DataflowAttribute keyword, a keyword of ‘initinit’ is assumed, unless the argument is marked ‘returns’, in which case ‘virinit’ is assumed.

The foregoing demonstrates the method by which the D language can be used to describe a computer architecture, and the method by which it can be used as an assembly language.

### Implementation of the Abstract Intrinsic Library

The collection of abstract types and interfaces intrinsic to the D language is called the abstract intrinsic library of the D language. Part of this library has been introduced in Listings 2 and 3, and in FIG. 1 and FIG. 2. It can be seen from the foregoing that concrete classes, specific to a single architecture, can be written in the D language to implement the abstract intrinsic library. As an example, the implementation is presented of classes implementing the interface ‘Int32_i’, a 32-bit integer, in the Intel® Architecture, using the D language.

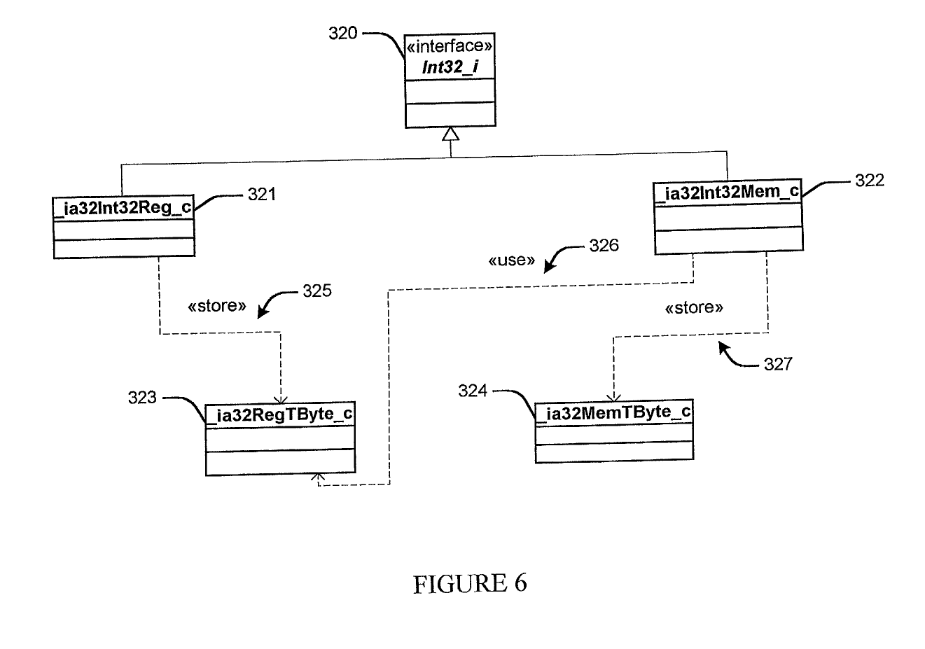

FIG. 6 is a UML diagram illustrating the implementation. Box 320 of FIG. 6 represents the interface ‘Int32_i’. Two classes implement the interface. The class ‘_ia32Int32Reg_c’ 321 stores its state in a general-purpose register, as shown by its <<store>> relationship 325 to the general-purpose register class ‘_ia32RegTByte_c’ 323. The class ‘_ia32Int32Mem_c’ 322 stores its state in memory, as shown by its <<store>> relationship 327 to the tetrabyte memory class ‘_ia32MemTByte_c’ 324. Note, however, the <<use>> relationship 326 from ‘_ia32Int32Mem_c’ 322 to ‘_ia32RegTByte_c’ 323. Except for a few restricted operations, the Intel® Architecture cannot perform arithmetic operations on values resident in memory. To perform arithmetic operations, values in memory must be copied to registers, the operations performed there, and results copied back.

Listing 7 gives part of the implementations of class ‘_ia32Int32Reg_c’, a 32-bit integer stored in a general-purpose register, and class ‘_ia32Int32Mem_c’, a 32-bit integer stored in main memory. Both of these classes declare that they implement interface ‘Int32_i’, the abstract interface to 32-bit integers whose definition is intrinsic to the D language. Objects of the class ‘_ia32Int32Reg_c’ store their state in a general-purpose register, while objects of the class ‘_ia32Int32Mem_c’ store their state in a tetrabyte in memory. Each class implements each method and function defined in ‘Int32_i’ several times. For a method defined in ‘Int32_i’ with n formal arguments of interface ‘Int32_i’, a class implements n² methods, such that every combination offormal arguments of classes ‘_ia32Int32Reg_c’ and ‘_ia32Int32Mem_c’ is implemented. This allows complete inter-operability between the two classes. This provides the D language compiler with the flexibility to allocate 32-bit integer objects to memory or general-purpose registers, based on its code generation and optimization algorithms.

In a traditional object-oriented language, such a completeness of overloading leads to unresolvable ambiguity errors. However, the D language compiler depends on information regarding subtype, representation, implementation, and subclass relationships to resolve ambiguities correctly. Furthermore, the D language definition provides that, if there is more than one possible legal resolution to an overloaded method or function reference, the D language compiler is free to choose any one of them, since by definition they must be semantically equivalent.

For example, if two classes implement the same interface, and code is being compiled that requires an object of that interface, the D language compiler is free to choose either one. As a second example, if a reference to an object of a certain class is required, and the D language compiler can supply a reference to an object of a subclass of that object, implementing the same interface, it may supply that reference.

It can be seen in Listing 7 that the classes ‘_ia32Int32Reg_c’ and ‘_ia32Int32Mem_c’ name a number of classes in FriendStatements. These statements reflect the fact that knowledge of the internal representations of all of the classes named is built into the underlying hardware.

### Overriding With Additional Arguments

Referencing the implementation of the method ‘assignSumOf’ in class ‘ia32Int32Reg_c’ beginning on line 376 of Listing 7, the formal arguments to the method include a named argument, ‘_ia32Flags’, indicating that this method modifies the computer's EFLAGS register. As this argument is marked ‘raninit’, and as it is a named argument, it does not need to be supplied explicitly by the source code invoking this method. Thus, this method implementation is still considered to implement the ‘Int32_i’ method ‘assignSumOf’ that requires only one argument.

The formal named argument ‘_ia32Flags’ informs the caller that the EFLAGS register will be modified by this method. The D language compiler uses this information to cause it to save and restore the state of the EFLAGS register if it needs to preserve its state around this method call.

### Encapsulation

This method ‘assignSumof’ beginning on line 376 of Listing 7 uses the underlying ADD instruction built into Intel Architecture® computers to accomplish the addition required. The instruction is encoded inline by invoking the ‘assignSumOf’ method of the class of ‘r’, defined on line 57 as this class's only data member. It then tests for overflow by calling a global subroutine, ‘_ia32InterruptIfOverflow’, which encodes the Intel® Architecture INTO instruction to invoke an interrupt handler if an arithmetic overflow occurs as a result of the addition.

The classes that implement the interface ‘Int32_i’ have access through their data members to all of the methods defined by the classes of their data members. Since their data members are of classes implemented directly in hardware, the classes that implement the interface ‘Int32_i’ have access to the hardware of Intel® Architecture computers. However, the interface ‘Int32_i’ has no methods such as AND and OR operations for operating on a 32-bit integer as a raw array of bits, such as AND and OR operations. By not exposing the underlying mechanisms, and by enforcing the rules of arithmetic through such means as overflow detection, these classes implementing ‘Int32_i’ encapsulate the Intel® Architecture with regard to integer arithmetic on 32-bit integers. By implementing the entire D language abstract intrinsic library in this manner for the Intel® Architecture, non-architecture-specific programs maybe written and bound to concrete architecture-specific implementations for the Intel® Architecture.

By describing a computer architecture in the D language in an object-oriented manner such as been shown herein, and by implementing the D language abstract intrinsic library for that architecture using its D language description, non-architecture-specific programs may be bound to that architecture as well.

### Temporary Objects

Typical contemporary computer architectures require that most data manipulation instructions have at least one operand in a general-purpose register, and the Intel® Architecture is no exception. This constraint sometimes requires a general-purpose register to be used during a computation. Formal arguments marked with the DataflowAttribute ‘ranran’ or simply ‘ran’ serve to inform code outside a method implementation that a temporary object is used.

Reference the implementation ofthe method ‘assignSumOf’ in class ‘_ia32Int32Mem_c’ beginning on line 809 of Listing 7. This embodiment of the method adds a memory-resident integer passed as an argument to the current object, which is also a memory-resident integer. Because computers of the Intel® Architecture do not possess an instruction to add one memory-resident integer to another, a general-purpose register must be used temporarily to compute the sum. The caller of this method is informed of this fact through the argument ‘ran var _ia32RegTByte_c Temp’. This implementation has one more argument than the method it implements in the interface ‘Int32_i’. It is marked ‘ran’ to indicate to a caller that its value has no meaning to the called routine upon its invocation, since it will immediately be overwritten, and that its final value has no meaning to the caller upon return. In fact, by inspecting the code of this method it can be seen that the actual argument will retain the sum calculated by the method. By hiding this fact with ‘ran’, the encapsulation in this class of the mechanics of computation is increased.

The D language compiler cannot generate code to invoke this ‘assignSumOf’ method without providing a general-purpose register as an argument. For example, consider the following D language source code fragment shown below without enclosing quotation marks:

new_ia32Int32Mem_c x (4);
new_ia32Int32Mem_c y (5);
y+= x;

In compiling this fragment, the D language compiler immediately converts the expression ‘y+=x’ to the expression ‘y.assignSumOf(x)’ and begins searching for a member method of class ‘_ia32Int32Mem_c’ named ‘assignSumOf’ that accepts a single argument of class ‘_ia32Int32Mem_c’. It cannot find one in the definition of class ‘_ia32Int32Mem_c’, as shown in Listing 7. It can find the method on line 809 which has two additional arguments, one with dataflow attribute ‘raninit’ and the other with dataflow attribute ‘ran’. Since both of these arguments supply no information to the method, the compiler can invoke the method if it provides the two arguments as valid objects of the classes specified by the formal arguments. The argument named ‘_ia32Flags’ is provided by virtue of it being named. Because of the dataflow attribute ‘raninit’ on the argument, the compiler must either ensure that it does not need to retain the state of‘_ia32Flags’ across the method invocation, or generate code to save the state of ‘_ia32Flags’ before the method is called. The same applies to argument named ‘Temp’. The D language compiler may then generate the source code shown below without enclosing quotation marks, based on its register allocation and optimization algorithms, and based on other code being compiled at the same time:

new_ia32Int32Mem_c x (4);
new_ia32Int32Mem_c y (5);
y·assignSumOf (x, eax);

This demonstrates the use of the D language to express the allocation of general-purpose registers to hold temporary values during computation. This capability is typical of intermediate languages designed to support compilation.

### Allocation

The Intel® Architecture supports the notion of a pushdown stack in main memory, used to allocate memory to objects local to a subroutine invocation. The general-purpose register ESP is defined by the architecture to be the stack pointer for the computer. Called subroutines typically allocate memory on the stack by decrementing ESP by the number of bytes they require on the stack. Memory allocated in this way is called a stack frame.

In order to maintain addressability to stack frames during subroutine execution, subroutines copy the value of ESP into the so-called frame pointer register, EBP, before decrementing ESP, and they do not change the value of EBP during their execution after this initial setup. Within the code of subroutines, references to local objects are made as negative offsets relative to the value of the EBP register. References to arguments passed on the stack are made as positive offsets relative to the value of the EBP register.

Subroutines also contain preamble code to save the value of the EBP register at entry, before setting its value for themselves, and postamble code to restore its original value at exit. This protects subroutines which call nested subroutines.

The D language requires that allocation of software-specified objects to pre-existing hardware objects be made explicit before those objects can be considered to exist. In order to express the allocation of objects to registers or main memory, the D language AtClause is used in a NewStatement, or an AtClause can be used alone in an AtStatement. It is important to understand that allocation is expressed in terms of objects and not addresses. An AtClause declares that one object, or one group of contiguous objects, is to be used to store the state of a software-specified object.

As an example, consider the following D language source code fragment, shown below without enclosing quotation marks:

new Subr_c sub
({

## . . .
new Int32_i x;
new Int32_i y;
## . . .
x+= y;

}) ;

This example illustrates that NewStatements can define new objects in terms of interfaces. In order to compile such NewStatements, the D language compiler must replace reference to interfaces with references to classes that implement those interfaces. If in a particular case there is more than one such class, the compiler is free to choose the class based on other criteria.

Suppose that, based on its optimization algorithms and based on other code not shown above, the D language compiler decides to allocate the object ‘x’ to general-purpose register EDX, and to allocate the object ‘y’ to memory, at a position on the stack frame 32 bytes below its beginning as indicated by frame pointer EBP. The D language compiler rewrites the above fragment to the fragment shown below without enclosing quotation marks:

new Subr_c<? ?> Sub
({

## . . .
new _iaInt32Reg_c at(edx) x;
new _iaInt32Mem_c at(_ia32MemMain [ebp−32 ˜ ebp−29]) y;
## . . .
x.assignSumOf (y);

}) ;

In this code, object ‘x’ is defined as an instance of the class of 32-bit integers that holds its state in a general-purpose register. The AtClause in the NewStatement defining ‘x’ declares that the register EDX is allocated to object ‘x’. By definition of the D language, no reference to the register EDX may be made in the scope of ‘x’, other than by members of the class of ‘x’. By similar means, the AtClause in the NewStatement defining ‘y’ declares that four contiguous main memory bytes, beginning at offset -32 from the current value in register EBP, are allocated to object ‘y’. No reference to these bytes may be made in the scope of ‘y’, other than by members of the class of ‘y’.

Through normal overload resolution, the D language compiler selects the version of method ‘as signSumOf’ implemented using the Intel® Architecture ADD instruction. By virtue of the D language source code describing that instruction, a ModR/M byte and an 8-bit displacement byte are generated which encode a reference to register EDX as instruction argument one, and the main memory address calculated by subtracting 32 from the value in EBP as instruction argument two.

### Storage Alignment

The AlignStatement of the D language is used to provide the D language compiler information it needs when allocating main memory to an object. Classes containing an AlignStatement are allocated by the D language compiler so that their first bytes are allocated to the underlying memory array at an index evenly divisible by the value of the expression given in the AlignStatement. This facility satisfies the need of computer architectures which have storage alignment requirements for various hardware-implemented classes of objects.

### Out-of-Line Subroutines

As has been mentioned, objects of class ‘Subr_c’ are only suitable for inline expansion. In other words, an expression invoking a subroutine of class ‘Subr_c’ may only be interpreted by replacing that expression with a copy of the body of the subroutine, with formal arguments replaced by actual arguments in the manner specified above.

In order to achieve a compiled program with some traditional out-of-line subroutines, other subclasses of subroutines must be defined, derived from ‘Subr_c’. The D language compiler is assured that substitution of a reference to an object of class ‘Subr_c’ with a reference to an object of a derived subroutine preserves the correctness of the program. The compiler makes such substitutions based on traditional optimization criteria determining when an out-of-line subroutine is preferable to an inline subroutine

In order to implement an out-of-line subroutine, a class derived from ‘Subr_c’ includes preamble code to save registers not mentioned as formal arguments, and code to set up a stack frame for the subroutine's local variables. Such a class also includes postamble code to restore registers and return control to the caller. Listing 11 shows the implementation of class ‘_ia32Cdecl_c’, implementing the so-called cdecl calling convention on the lntel® Architecture. The cdecl calling convention is that used by standard C language functions compiled for the Intel® Architecture.

It can be seen on line 13 of Listing 11 that class ‘_ia32Cdecl_c’ is a parameterized class. The parameter to the class is an object of class ‘FormalArgs_c’, which represents the formal arguments of the subroutine being implemented as an out-of-line subroutine. The class literal on line 13 declares that it extends (derives from) the class ‘Subr_c’ as parameterized by ‘FormalArgs’. The first member inside the class literal is a data member of class ‘Xferr_c’. This identifier stands for “transfer routine class”, a non-sequential routine class. Unlike a subroutine, which always guarantees to return control to the point immediately after that which gave it control, a transfer routine guarantees that it will not return control to that point. This non-sequential control flow is indicated by the intrinsic definition of class ‘Xferr_c’ in the D language.

On lines 18-34 of Listing 11 it can be seen that an initializer of class ‘Xferr_c’ is called with a single argument, the result of invoking an initializer of class ‘FormalArgs_c’. This initializer is called with two arguments, the first being the ‘FormalArgs’ passed to the outer class, and the second being an instance of ‘FormalArgs_c’ initialized with a FormalArguments literal. These two formal argument objects are concatenated into one by the initializer of class ‘FormalArgs_c’ to which they are passed. Thus, the parameterized class ‘Xferr_c’ is parameterized by two sets of formal arguments, the formal arguments of the subroutine being initialized to be called out-of-line, and the FormalArguments literal which reflect facts about the calling convention in use.

This FormalArguments literal declares four named formal arguments with dataflow attribute ‘ran’. These inform the invoker of the routine object ‘Body’ that the named general-purpose registers and flags register do not pass information into the routine, nor do they return information from the routine, but they may be modified by the routine. In other words, the state of these registers is not saved across execution of ‘Body’. These named arguments reflect part of the so-called calling convention embodied in the class ‘_ia32Cdecl_c’. Other calling conventions can be implemented by other subroutine classes by saving and restoring a different set of registers in the subroutine preamble and postamble body literal in the class initializer, and by declaring the registers not saved as named formal arguments with dataflow attribute ‘ran’.

The ‘pReturn’ argument in the FonnalArguments literal is passed to the routine at the address indicated by stack pointer ESP, and this fact is declared in the AtClause associated with the argument. These declarations reflect the Intel® Architecture's implementation of a subroutine call mechanism, namely that the calling code, by virtue of the CALL instruction, places the subroutine's return address on the stack. The Intel® Architecture's RET instruction pops the address from the stack. This fact is reflected by the dataflow attribute of the ‘pReturn’ argument, ‘initdel’, indicating that upon transfer of control to the routine ‘pReturn’ has a meaningful value, but on return from the routine ‘pReturn’ has been finalized.

The EnsureClauses of the FormalArguments literal on lines 31-32_indicate that the stack is popped by four bytes, and that the instruction pointer register of the Intel® Architecture, EIP, is set to the return address at completion of execution of ‘Body’.

The result of these declarations is that the data member ‘Body’ of the parameterized class ‘_ia32Cdecl_c’ is correctly described as the body of an out-of-line subroutine which expects its return address on the top of the stack, and which, as its final act, pops the return address and transfers control to it.

As can be seen on lines 39-44 of Listing 11, the initializer of class ‘_ia32Cdecl_c’ takes two arguments, a subroutine object and a stack frame size (in bytes). The ‘initialize’ method initializes its data member ‘Body’ with a subroutine literal that refers to these two arguments. The ‘sFrame’ argument is used in the statement ‘esp−=sFrame;’ to create space on the pushdown stack for local objects. The subroutine object itself, identified by formal argument ‘s_’, is placed inline in the subroutine literal using an InlineStatement.

The FormalArguments literal of the ‘call’ function of class ‘_ia32Cdecl_c’, defined on lines 69-74 of Listing 11, repeat some of the declarations of the FormaLArguments literal passed to class ‘xf err_c’, as these facts about the alteration of registers remain true across the execution of the call to ‘Body’. However, there is no mention in this latter FormalArguments literal of a return address, nor of the popping of a return address from the stack. This is because the hardware call instruction, described by the global subroutine ‘_ia32_call’, pushes the return address as part of its behavior. This fact, coupled with the behavior of ‘Body’ just described, means that the call/return mechanism is invisible to the caller of ‘Body’. This satisfies the semantic requirement that a call/retum mechanism for invoking a subroutine be equivalent to the copying of the subroutine inline at the point of its invocation.

Given the code above for the subroutine object named ‘Sub’, the D language compiler creates a callable out-of-line version by initializing an instance of ‘_ia32Cdecl_c’ with the subroutine object, as in the D language source code shown below without enclosing quotation marks:

new _ia32Cdecl_c CallableSub(Sub);

The callable version of ‘Sub’, ‘CallableSub’, can be invoked out-of-line by invoking the ‘call’ function on it, as in the D language source code shown below without enclosing quotation marks:

CallableSub.call( );

Since the D language interprets the invocation of a ‘Subr_c’ object by copying its code inline, and since the ‘call’ function is defined as an instance of ‘Subr_c’, the compiler compiles the above source code by replacing the expression with an Intel® Architecture CALL instruction.

These facts and equivalencies allow the D language compiler to create a callable copy of any subroutine using a calling convention class available to it, and to rewrite an inline subroutine invocation as a call to a callable copy of that subroutine.

### Argument Passing

On line 25 of Listing 11, an AtClause is used in a FormalArguments literal, to indicate where a called routine may find an argument. In fact, every argument to a called routine must have its allocation made explicit. As part of rewriting code to allow a routine to be called, the D language compiler allocates storage for arguments, and expresses that allocation in the FormalArguments for the callable version of the routine. The convention by which the compiler allocates storage for arguments is part of the so-called calling convention.

For example, consider a subroutine defined to take one argument, as shown below in the D language without enclosing quotation marks:

new Subr_c<? Int32_I A ?>Sub;

When rewriting ‘Sub’ as an out-of-line subroutine, in accordance with the cdecl calling convention, the D language compiler allocates storage for ‘A’ at the bottom of the stack, just before the return address pushed by the CALL instruction. The rewritten code is shown below without enclosing quotation marks:

new _ia32CDecl_c<? Int32_I at(esp+4) A ?> CallableSub(Sub);

The code to call ‘CallableSub’ out-of-line is shown below without enclosing quotation marks:

Stack.push (ActualA) ;
CallableSub.call () ;

### Other Routine Classes

The D language defines other routine classes, specifically a conditional transfer class ‘Cxferr_c’, which may transfer control non-sequentially or may allow it to proceed sequentially, and a halt class ‘Haltr_c’, which stops sequential execution entirely. These classes are necessary to express branch and halt instructions found in computers. The traditional go to statement of other languages is implemented in the D language as a routine of class ‘Xferr_c’.

For architectures which define delayed branches, where instructions following branch instructions are executed before branches are taken, a parameterized routine class is defined which takes the instruction following the branch as one of its arguments.

### Class Data Members

It should be clear from the foregoing that all of the classes described so far have no methods or functions using dynamic dispatch. In other words, the class of every object is statically known. This fact allows the data portion of these classes to encompass exactly those data members described in source code, without the implicit overhead of such things as virtual routine table pointers. This is necessary to allow descriptions in the D language of hardware which, of course, contains no such implicit pointers.

However, classes include implicit virtual table pointers when functions or methods are declared ‘extensible’. This feature supports the polymorphism necessary for object-oriented programming. The fact that polymorphic classes cannot be used to describe hardware directly does not limit them from being implemented in terms of non-polymorphic classes. Nor is there any problem intermixing the use of polymorphic and non-polymorphic classes in the same source code.

### Compilation of Literals

The D language definition, as presented herein, allows class ‘Subr_c’, classes derived from it, and other routine classes to have one or more methods defined that take as argument an object whose class represents literals of the syntactic category StatementBlock, which is a sequence of zero or more Statements enclosed in braces. In fact, such methods are defined. The D language compiler, upon seeing a statement of the form ‘new Subr_c<? Arg_c Arg ?> id({ statement; })’,encodes an invocation of an initializer of class ‘Subr_c<? Arg_c Arg ?>’, passing to it as actual argument the compiler's internal representation of the StatementBlock literal. By this means, the initializer method is able to interpret the StatementBlock literal in the context of the formal arguments expressed in the FormalArguments literal, and to compile the StatementBlock literal.

By definition of the D language, every literal of the language, whether a lexical literal or a syntactic literal, is available as an object to source code in the language. The D language compiler employs this fact to externalize much of its code into methods of classes intrinsic to the language.

### Routines and Classes as Objects

Not only can source code be written in the D language to compile D language literals, but source code can also be written to invoke methods on class objects, routine objects, and any other objects whose classes are intrinsic to the language. This fact allows traditional text-based code generation methods to be replaced by object-oriented code generation methods.

### Universal Assembly Language

It should already be clear from the above that computer architectures can be described in the D language, and that programs can be written in the D language which are specific to computer architectures so described. Thus, the D language is a universal assembly language.

It also follows from the above that any assembly language program already written for a computer architecture which has been described in the D language, may be translated from that assembly language into the D language, with little or no difficulty. In many cases (where there is little use of higher-level facilities such as macros), the translation is trivial (mere syntax changes) and can be done automatically.

### Programming in an Architecture-Independent Manner

In order to write architecture-independent programs in the D language, a programmer need only refrain from using any architecture-dependent implementation classes. The design of the abstract intrinsic library is such that a programmer will find all of the primitive types, interfaces, classes, etc., necessary to write any program in the D language, without resorting to any architecture-specific source code. However, should a programmer need to write architecture-specific code, there is nothing to prevent him from doing so in the D language, without resorting to assembly language as is traditionally done.

### Re-Targeting a Program

Re-targeting a program is modifying and compiling a possibly architecture-dependent program for an architecture other than the one for which it was originally intended. An attempt to re-target most architecture-dependent programs is an ambitious one. This is because the original architecture-dependent program makes assumptions throughout about the identity, structure, and behavior of physical objects composing the target computer. If an architecture-dependent program is to be run on a computer of an architecture other than the one initially targeted, either the program must be modified to remove these assumptions, or the assumptions must be satisfied on the new computer (this latter is known as emulation). Either of these tasks is non-trivial. Emulating the original architecture on a new target architecture has the advantage that it is a general solution for any architecture-dependent program written for the original architecture, but usually causes a significant slowdown in the execution of the re-targeted program, as many processor cycles are consumed merely emulating the original architecture within the new architecture, rather than carrying out the intent of the original program. By contrast, modifying the original program to re-target it produces a faster running re-targeted program, but is a labor-intensive process which must be repeated for every program to be re-targeted.

The D language and compiler allow a new method of re-targeting an architecture-dependent program without emulation, as follows. Firstly, the program to be re-targeted must be expressed in the language of the present invention, such as the D language. As mentioned above, if the program is written in an assembly language, it may be trivial to rewrite. If the program is written in a different high-level language, conversion to a language such as the D language may have to be done by hand.

Secondly, an abstract description is written of the architecture for which the program was originally intended. Each class of physical object of a computer of the original architecture is described in the manner set forth above. However, no HardwareStatements are included in the source code indicating the physical presence of those objects.

Thirdly, the abstract description of the original architecture is implemented in terms of the abstract intrinsic library of the D language. Software objects are declared with the same global identifiers as used in the original code for the corresponding real objects on the original computer. These software objects are instances of the classes describing the original architecture.

Finally, the original program and the implementation of the abstract description of the original architecture are compiled with a compiler for the new target architecture. The result is a machine-language program for the new target architecture which is an equivalent of the original program.

### Cross-Compilation

Cross-compilation is executing a compiler on a computer conforming to one architecture, in order to produce a machine-language program for a second architecture. The present invention makes possible a new method of cross-compilation, as follows. A collection of implementations of the abstract intrinsic library is made available to the D language compiler, where each implementation is for a different computer architecture, none of which is necessarily the architecture of the computer executing the compiler. Each of these implementations of the abstract intrinsic library contains HardwareStatements containing the keyword ‘remote’ rather than the keyword ‘local’, indicating to the D language compiler that the hardware object indicated exists on some computer other than the one on which the compiler is executing. Also made available to the compiler is a collection of implementation libraries of architecture-dependent register allocation and optimization algorithms, to be executed as part of the compilation process. The collection contains one such set of architecture-dependent algorithm implementations per implementation of the abstract intrinsic library in the other collection. The compiler selects one of the abstract intrinsic library implementations representing the architecture for which code will be compiled, and an allocation and optimization library from the other collection for the same architecture. By binding in an architecture-specific implementation of the abstract intrinsic library, and allocating and optimizing for the same architecture, the compiled code will be prepared for execution on a computer of the corresponding architecture.

This approach goes further than prior cross-compilation inventions, by incorporating the description of the target architecture in the code to be compiled.

As described above, the present invention can be embodied in the form of computer-implemented processes and apparatuses for practicing those processes. The present invention can also be embodied in the form of computer program code containing instructions embodied in tangible media, such as floppy diskettes, CD-ROM's, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium (embodied in the form of a propagated signal propagated over a propagation medium, with the signal containing the instructions embodied therein), such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. A computer programming method comprising:
describing data types as abstract without default or implicit implementations and distinctly from classes or interfaces;
describing subtype and supertype relationships between the types; and
describing representations of values of the types as states of classes of objects with interfaces.

2. The computer programming method of claim 1 further comprising:
describing software-visible physical objects and an instruction set using object-oriented classes; and
identifying when classes are implemented by a computer.

3. The computer programming method of claim 1 further comprising:
describing multiple classes of pointer objects, said pointer objects capable of signifying objects.

4. The computer programming method of claim 1 further comprising:
describing commands for transferring program control in non-sequential ways as routines.

5. The computer programming method of claim 1 further comprising:
describing at least one of interfaces, classes, enumerations, subroutines, and other routines as classes of objects.

6. The computer programming method of claim 1 further comprising:
invoking statements in a compilation with results thereofbeing incorporated into an output of a compiler.

7. The computer programming method of claim 1 further comprising:
invoking statements in a compilation to interpret literals in an input of a compiler.

8. The computer programming method of claim 1 further comprising:
deriving variable classes from a constant class; and
describing one of the variable classes and the constant class using a single descriptor.

9. The computer programming method of claim 1 further comprising:
deriving variable interfaces from a constant interface; and
describing one of the variable interfaces and the constant interface using a single descriptor.

10. The computer programming method of claim 1 further comprising:
describing formal arguments to routines as objects.

11. The computer programming method of claim 1 further comprising:
describing formal arguments to routines as a number of arguments including type, interface, or class of each argument, dataflow attribute of each argument, and preconditions and postconditions of routines.

12. The computer programming method of claim 1 further comprising:
describing subroutines as parameterized classes.

13. A method of compilation comprising:
a. generating a description of a computer architecture as a first library, the description including software-visible objects and the instruction set;
b. implementing a second library of high level objects using the first library; and
c. binding a source program to implementations in the second library to produce machine instructions dependent on the computer architecture.

14. A method of re-targeting comprising:
a. generating a first description of a first computer architecture as a first library, the first description including software-visible objects and instruction set therefor;
b. generating a second description of a second computer architecture as a second library, the second description including software-visible objects and instruction set therefor;
c. implementing the first description using the second library to produce a third library; and
d. binding a source program to implementations in the third library to produce machine instructions dependent on the second computer architecture.

15. A computer programming method comprising:
describing software-visible physical objects and an instruction set using object-oriented classes; and
identifying when classes are implemented by a computer.

16. A computer programming method comprising:
deriving variable classes from a constant class; and
describing one of the variable classes and the constant class using a single descriptor.

17. A storage medium encoded with machine-readable code, the code including instructions for allowing a computer to implement a computer programming method comprising:
describing data types as abstract without default or implicit implementations and distinctly from classes or interfaces;
describing subtype and supertype relationships between the types; and
describing representations of values of the types as states of classes of objects with interfaces.

18. The storage medium of claim 17 wherein the method further comprises:
describing software-visible physical objects and an instruction set using object-oriented classes; and
identifying when classes are implemented by a computer.

19. The storage medium of claim 17 wherein the method further comprises:
describing multiple classes of pointer objects, said pointer objects capable of signifying objects.

20. The storage medium of claim 17 wherein the method further comprises:
describing commands for transferring program control in non-sequential ways as routines.

21. The storage medium of claim 17 wherein the method further comprises:
describing at least one of interfaces, classes, enumerations, subroutines, and other routines as classes of objects.

22. The storage medium of claim 17 wherein the method further comprises:
invoking statements in a compilation with results thereof being incorporated into an output of a compiler.

23. The storage medium of claim 17 wherein the method further comprises:
invoking statements in a compilation to interpret literals in an input of a compiler.

24. The storage medium of claim 17 wherein the method further comprises:
deriving variable classes from a constant class; and
describing one of the variable classes and the constant class using a single descriptor.

25. The storage medium of claim 17 wherein the method fiLrther comprises:
deriving variable interfaces from a constant interface; and
describing one of the variable interfaces and the constant interface using a single descriptor.

26. The storage medium of claim 17 wherein the method further comprises:
describing formal arguments to routines as objects.

27. The storage medium of claim 17 wherein the method further comprises:
describing formal arguments to routines as a number of arguments including type, interface, or class of each argument, dataflow attribute of each argument, and preconditions and postconditions of routines.

28. The storage medium of claim 17 wherein the method further comprises:
describing subroutines as parameterized classes.

29. A storage medium encoded with machine-readable code for compilation, the code including instructions for causing a computer to implement a method comprising:
a. generating a description of a computer architecture as a first library, the description including software-visible objects and the instruction set;
b. implementing a second library of high level objects using the first library; and
c. binding a source program to implementations in the second library to produce machine instructions dependent on the computer architecture.

30. A storage medium encoded with machine-readable code for re-targeting, the code including instructions for causing a computer to implement a method comprising:
a. generating a first description of a first computer architecture as a first library, the first description including software-visible objects and instruction set therefor;
b. generating a second description of a second computer architecture as a second library, the second description including software-visible objects and instruction set therefor;
c. implementing the first description using the second library to produce a third library; and
d. binding a source program to implementations in the third library to produce machine instructions dependent on the second computer architecture.

31. A storage medium encoded with machine-readable code, the code including instructions for allowing a computer to implement a computer programming method:
describing software-visible physical objects and an instruction set using object-oriented classes; and
identifying when classes are implemented by a computer.

32. A storage medium encoded with machine-readable code, the code including instructions for allowing a computer to implement a computer programming method:
deriving variable classes from a constant class; and
describing one of the variable classes and the constant class using a single descriptor.

33. A signal propagated over a propagation medium, the signal encoded with code including instructions for allowing a computer to implement a computer programming method comprising:
describing data types as abstract without default or implicit implementations and distinctly from classes or interfaces;
describing subtype and supertype relationships between the types; and
describing representations of values of the types as states of classes of objects with interfaces.

34. The signal propagated over the propagation medium of claim 33 wherein the method further comprises:
describing software-visible physical objects and an instruction set using object-oriented classes; and
identifying when classes are implemented by a computer.

35. The signal propagated over the propagation medium of claim 33 wherein the method further comprises:
describing multiple classes of pointer objects, said pointer objects capable of signifying objects.

36. The signal propagated over the propagation medium of claim 33 wherein the method further comprises:
describing commands for transferring program control in non-sequential ways as routines.

37. The signal propagated over the propagation medium of claim 33 wherein the method further comprises:
describing at least one of interfaces, classes, enumerations, subroutines, and other routines as classes of objects.

38. The signal propagated over the propagation medium of claim 33 wherein the method further comprises:
invoking statements in a compilation with results thereof being incorporated into an output of a compiler.

39. The signal propagated over the propagation medium of claim 33 wherein the method further comprises:
invoking statements in a compilation to interpret literals in an input of a compiler.

40. The signal propagated over the propagation medium of claim 33 wherein the method further comprises:
deriving variable classes from a constant class; and
describing one of the variable classes and the constant class using a single descriptor.

41. The signal propagated over the propagation medium of claim 33 wherein the method further comprises:
deriving variable interfaces from a constant interface; and
describing one of the variable interfaces and the constant interface using a single descriptor.

42. The signal propagated over the propagation medium of claim 33 wherein the method further comprises:
describing formal arguments to routines as objects.

43. The signal propagated over the propagation medium of claim 33 wherein the method further comprises:
describing formal arguments to routines as a number of arguments including type, interface, or class of each argument, dataflow attribute of each argument, and preconditions and postconditions of routines.

44. The signal propagated over the propagation medium of claim 33 wherein the method further comprises:
describing subroutines as parameterized classes.

45. A signal propagated over a propagation medium, the signal encode with code for compilation, the code including instructions for causing a computer to implement a method comprising:
a. generating a description of a computer architecture as a first library, the description including software-visible objects and the instruction set;
b. implementing a second library of high level objects using the first library; and
c. binding a source program to implementations in the second library to produce machine instructions dependent on the computer architecture.

46. A signal propagated over a propagation medium, the signal encode with code for re-targeting, the code including instructions for causing a computer to implement a method comprising:
a. generating a first description of a first computer architecture as a first library, the first description including software-visible objects and instruction set therefor;
b. generating a second description of a second computer architecture as a second library, the second description including software-visible objects and instruction set therefor;
c. implementing the first description using the second library to produce a third library; and
d. binding a source program to implementations in the third library to produce machine instructions dependent on the second computer architecture.

47. A signal propagated over a propagation medium, the signal encoded with code including instructions for allowing a computer to implement a computer programming method comprising:
describing software-visible physical objects and an instruction set using object-oriented classes; and
identifying when classes are implemented by a computer.

48. A signal propagated over a propagation medium, the signal encoded with code including instructions for allowing a computer to implement a computer programming method comprising:
deriving variable classes from a constant class; and
describing one of the variable classes and the constant class using a single descriptor.
